(19) United States
(12) Patent Application Publication
(10) Pub. No.: US 2017/0052586 A1
(43) Pub. Date: Feb. 23, 2017

(54) TRANSPARENTLY MONITORING POWER DELIVERY IN A PROCESSOR

(71) Applicant: Intel Corporation, Santa Clara, CA (US)

(72) Inventor: Jay Nejedlo, Wilsonville, OR (US)

(21) Appl. No.: 14/827,660

(22) Filed: Aug. 17, 2015

(51) Int. Cl. G06F 1/32; G06F 1/28

(52) U.S. Cl. CPC G06F 1/3296; G06F 1/28

(57) ABSTRACT

In one embodiment, a processor includes: at least one domain to operate at an independent voltage and frequency and including a monitor circuit; and a power controller to control power consumption of the at least one domain and to control the monitor circuit to monitor an operating voltage of the at least one domain during active operation of the at least one domain and to prevent the monitor circuit from the monitoring of the operating voltage when the at least one domain is inactive. Other embodiments are described and claimed.

### TECHNICAL FIELD

Embodiments relate to power-related monitoring of a system, including power-related monitoring of a processor.

### BACKGROUND

Advances in semiconductor processing and logic design have permitted an increase in the amount of logic that may be present on integrated circuit devices. As a result, computer system configurations have evolved from a single or multiple integrated circuits in a system to multiple hardware threads, multiple cores, multiple devices, and/or complete systems on individual integrated circuits. Additionally, as the density of integrated circuits has grown, the power requirements for computing systems (from embedded systems to servers) have also escalated. Furthermore, software inefficiencies, and its requirements of hardware, have also caused an increase in computing device energy consumption. In fact, some studies indicate that computing devices consume a sizeable percentage of the entire electricity supply for a country, such as the United States of America. As a result, there is a vital need for energy efficiency and conservation associated with integrated circuits. These needs will increase as servers, desktop computers, notebooks, Ultrabooks™, tablets, mobile phones, processors, embedded systems, etc. become even more prevalent (from inclusion in the typical computer, automobiles, and televisions to biotechnology).

### BRIEF DESCRIPTION OF THE DRAWINGS

FIG. 1 is a block diagram of a portion of a system in accordance with an embodiment of the present invention.

FIG. 2 is a block diagram of a processor in accordance with an embodiment of the present invention.

FIG. 3 is a block diagram of a multi-domain processor in accordance with another embodiment of the present invention.

FIG. 4 is an embodiment of a processor including multiple cores.

FIG. 5 is a block diagram of a micro-architecture of a processor core in accordance with one embodiment of the present invention.

FIG. 6 is a block diagram of a micro-architecture of a processor core in accordance with another embodiment.

FIG. 7 is a block diagram of a micro-architecture of a processor core in accordance with yet another embodiment.

FIG. 8 is a block diagram of a micro-architecture of a processor core in accordance with a still further embodiment.

FIG. 9 is a block diagram of a processor in accordance with another embodiment of the present invention.

FIG. 10 is a block diagram of a representative SoC in accordance with an embodiment of the present invention.

FIG. 11 is a block diagram of another example SoC in accordance with an embodiment of the present invention.

FIG. 12 is a block diagram of an example system with which embodiments can be used.

FIG. 13 is a block diagram of another example system with which embodiments may be used.

FIG. 14 is a block diagram of a representative computer system.

FIG. 15 is a block diagram of a system in accordance with an embodiment of the present invention.

FIG. 16 is a block diagram of a processor in accordance with an embodiment of the present invention.

FIG. 17 is a flow diagram of a voltage monitoring method in accordance with an embodiment of the present invention.

FIG. 18 is a flow diagram of further details of a voltage monitoring method in accordance with an embodiment.

FIG. 19 is a block diagram illustrating further details of a voltage monitor circuit in accordance with an embodiment.

FIG. 20 is a block diagram of a power control unit in accordance with an embodiment of the present invention.

FIG. 21 is a block diagram of details of storage registers in accordance with an embodiment of the present invention.

FIG. 22 is a block diagram illustrating an IP core development system used to manufacture an integrated circuit to perform operations according to an embodiment.

### DETAILED DESCRIPTION

In various embodiments, power integrity validation (PIV) for a power delivery network (PDN) of a computing system including one or more processors or other systems on chip (SoC) can be realized by incorporating circuitry within the processor to perform power-related measurement operations throughout execution during operating system (OS)-based application execution. Embodiments further enable performance tuning at the system level to realize improvements in platform autonomics. Further, embodiments provide for dynamic workload balancing and workload characterization optimization.

Embodiments may also be used to realize dynamic optimization of data center and other collections of servers and other computing devices that implement dynamic reallocation of resources. This use can be performed using a validation stress suite or industry applications including benchmarks for workload characterization, in a manner that avoids communication of telemetry information externally from the system by leveraging power grid data, as described herein. Embodiments may further perform utilization baseline analysis, avoiding the need for other telemetry systems used for fingerprinting, as power/energy monitoring as described herein can be used to find hotspots during workloads. That is, instead of coupling a system under test to various external test equipment such as oscilloscopes, logic analyzers or other such test equipment, embodiments can perform power-related monitoring in any given system. In this way, all such monitoring can be implemented internal to the device under test, without the need for telemetry or other external systems. Note of course that the monitoring information can be communicated to one or more destinations both internal and external to the device under test. Still further, understand that the monitoring and testing described herein can be performed in a wide variety of conditions and situations, including validation, testing, and debug performed by a manufacturer of the processor or SoC, a manufacturer of the system (such as a given original equipment manufacturer (OEM)), or a given customer, such as a datacenter entity, end user, or so forth.

Embodiments may also facilitate automated voltage tolerance testing transparently within a system without violating the Heisenberg Effect. That is, the testing described herein does not affect or perturb normal operation of the system such that no variances in the monitored parameters (including power-related parameters) occur as a result of the testing itself. In addition, both temporal and spatial diagnostic granularity is provided, reducing dramatically test-to-debug time to be on the order of hours vs. day/weeks. Embodiments may also provide power delivery quality information (e.g., voltage tolerance adherence) during OS stress testing in many validation flows, including power integrity validation (PIV), post-production volume (PPV), electrical validation of IOs (EVIOs), circuit marginality validation (CMV) and power performance flows. Still further using embodiments, the above-described power validation operations can be performed on actual customer platforms (customer bills of material (BOMs)), instead of specialized validation-specific platforms avoiding the need for special platform level observability.

In various embodiments a power management unit of a processor, such as a PCU, may be configured to orchestrate power-related monitoring while the system is in normal operating states. This PCU may determine, based at least in part on power management state, power management table selections, ratio changes, OS requests for power management state, (and incoming update requests of one or more cores or other IP logics of a processor), and during OS application execution when voltage monitoring is to be active and when it is to be suspended.

As will be described herein, monitoring circuitry may include internal circuitry to facilitate the initiation or suspension/restart of monitoring through time. In an embodiment, the monitoring circuitry may include hardware to provide the ability to retain configuration and data during unpowered states. This monitoring can be enabled for any given time frame indefinitely to support power tolerance profiling and/or platform management related dynamic workload characterization. In this way, telemetry circuitry can be eliminated, as embodiments may monitor voltage persistently during normal system operation.

In various embodiments, architectural features of a processor may be used to perform power delivery monitoring using a normal operating autonomy of a system. Such features include power management-controlled monitoring resources. Additional features include specialized voltage monitoring substructures that are instantiated in IP blocks of the processor, as well as any other IP block within a component package (i.e., an SoC). As such, all monitoring and controlling features are wholly contained within the processor itself and/or component package, eliminating interaction with external equipment or specialized test hosts.

Although the following embodiments are described with reference to energy conservation and energy efficiency in specific integrated circuits, such as in computing platforms or processors, other embodiments are applicable to other types of integrated circuits and logic devices. Similar techniques and teachings of embodiments described herein may be applied to other types of circuits or semiconductor devices that may also benefit from better energy efficiency and energy conservation. For example, the disclosed embodiments are not limited to any particular type of computer systems. That is, disclosed embodiments can be used in many different system types, ranging from server computers (e.g., tower, rack, blade, micro-server and so forth), communications systems, storage systems, desktop computers of any configuration, laptop, notebook, and tablet computers (including 2:1 tablets, phablets and so forth), and may be also used in other devices, such as handheld devices, systems on chip (SoCs), and embedded applications. Some examples of handheld devices include cellular phones such as smartphones, Internet protocol devices, digital cameras, personal digital assistants (PDAs), and handheld PCs. Embedded applications may typically include a microcontroller, a digital signal processor (DSP), network computers (NetPC), set-top boxes, network hubs, wide area network (WAN) switches, wearable devices, or any other system that can perform the functions and operations taught below. More so, embodiments may be implemented in mobile terminals having standard voice functionality such as mobile phones, smartphones and phablets, and/or in non-mobile terminals without a standard wireless voice function communication capability, such as many wearables, tablets, notebooks, desktops, micro-servers, servers and so forth. Moreover, the apparatuses, methods, and systems described herein are not limited to physical computing devices, but may also relate to software optimizations for energy conservation and efficiency. As will become readily apparent in the description below, the embodiments of methods, apparatuses, and systems described herein (whether in reference to hardware, firmware, software, or a combination thereof) are vital to a ‘green technology’ future, such as for power conservation and energy efficiency in products that encompass a large portion of the US economy.

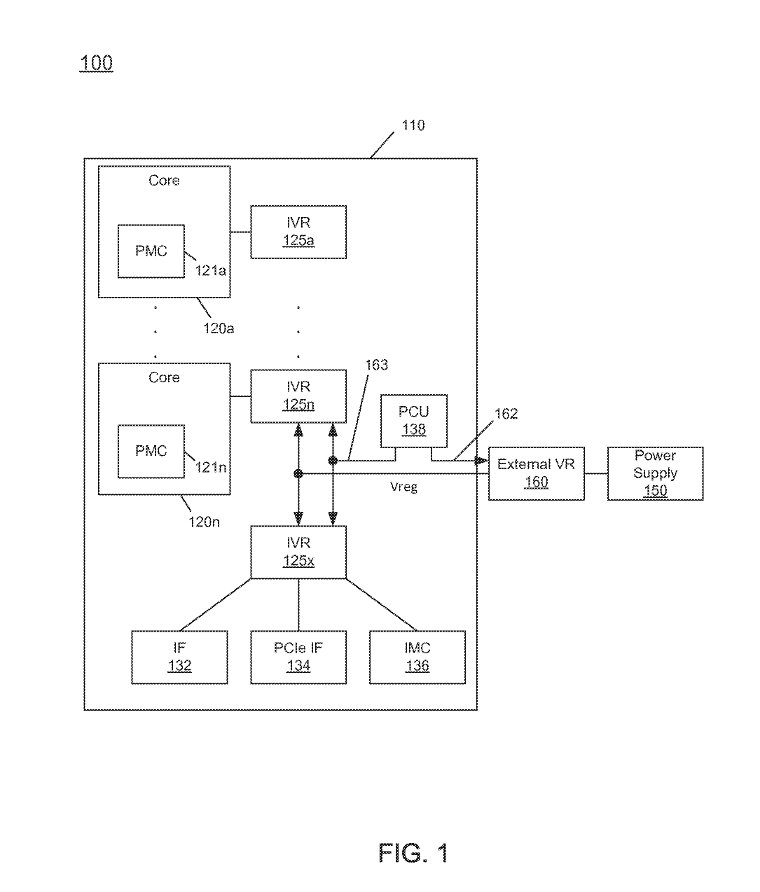

Referring now to FIG. 1, shown is a block diagram of a portion of a system in accordance with an embodiment of the present invention. As shown in FIG. 1, system 100 may include various components, including a processor 110 which as shown is a multicore processor. Processor 110 may be coupled to a power supply 150 via an external voltage regulator 160, which may perform a first voltage conversion to provide a primary regulated voltage Vreg to processor 110.

As seen, processor 110 may be a single die processor including multiple cores 120a-120n. In addition, each core may be associated with an integrated voltage regulator (IVR) 125a-125n which receives the primary regulated voltage and generates an operating voltage to be provided to one or more agents of the processor associated with the IVR. Accordingly, an IVR implementation may be provided to allow for fine-grained control of voltage and thus power and performance of each individual core. As such, each core can operate at an independent voltage and frequency, enabling great flexibility and affording wide opportunities for balancing power consumption with performance. In some embodiments, the use of multiple IVRs enables the grouping of components into separate power planes, such that power is regulated and supplied by the IVR to only those components in the group. During power management, a given power plane of one IVR may be powered down or off when the processor is placed into a certain low power state, while another power plane of another IVR remains active, or fully powered. Similarly, cores 120 may include or be associated with independent clock generation circuitry such as one or more phase lock loops (PLLs) to control operating frequency of each core 120 independently. As further illustrated, each of multiple domains of processor 100, including cores 120ₐ-120ₙ, may include one or more independent power monitoring circuits 121ₐ-121ₙ. As described herein, these power monitoring circuits may be used to seamlessly monitor a power delivery network without the need for external telemetry systems or other test equipment.

Still referring to FIG. 1, additional components may be present within the processor including an input/output interface (IF) 132, another interface 134, and an integrated memory controller (IMC) 136. As seen, each of these components may be powered by another integrated voltage regulator 125ₓ. In one embodiment, interface 132 may enable operation for an Intel® Quick Path Interconnect (QPI) interconnect, which provides for point-to-point (PtP) links in a cache coherent protocol that includes multiple layers including a physical layer, a link layer and a protocol layer. In turn, interface 134 may communicate via a Peripheral Component Interconnect Express (PCIe™) protocol.

Also shown is a power control unit (PCU) 138, which may include circuitry including hardware, software and/or firmware to perform power management operations with regard to processor 110. As seen, PCU 138 provides control information to external voltage regulator 160 via a digital interface 162 to cause the voltage regulator to generate the appropriate regulated voltage. PCU 138 also provides control information to IVRs 125 via another digital interface 163 to control the operating voltage generated (or to cause a corresponding IVR to be disabled in a low power mode). In various embodiments, PCU 138 may include a variety of power management logic units to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software). Understand that PCU 138 may further be involved in a power delivery network monitoring operations, in some instances responsive to direction from firmware and/or an operating system.

While not shown for ease of illustration, understand that additional components may be present within processor 110 such as uncore logic, and other components such as internal memories, e.g., one or more levels of a cache memory hierarchy and so forth. Furthermore, while shown in the implementation of FIG. 1 with an integrated voltage regulator, embodiments are not so limited. For example, other regulated voltages may be provided to on-chip resources from external voltage regulator 160 or one or more additional external sources of regulated voltages.

Note that the power management techniques described herein may be independent of and complementary to an operating system (OS)-based power management (OSPM) mechanism. According to one example OSPM technique, a processor can operate at various performance states or levels, so-called P-states, namely from P0 to PN. In general, the P1 performance state may correspond to the highest guaranteed performance state that can be requested by an OS. In addition to this P1 state, the OS can further request a higher performance state, namely a P0 state. This P0 state may thus be an opportunistic or turbo mode state in which, when power and/or thermal budget is available, processor hardware can configure the processor or at least portions thereof to operate at a higher than guaranteed frequency. In many implementations a processor can include multiple so-called bin frequencies above the P1 guaranteed maximum frequency, exceeding to a maximum peak frequency of the particular processor, as fused or otherwise written into the processor during manufacture. In addition, according to one OSPM mechanism, a processor can operate at various power states or levels. With regard to power states, an OSPM mechanism may specify different power consumption states, generally referred to as C-states, C0, C1 to Cn states. When a core is active, it runs at a C0 state, and when the core is idle it may be placed in a core low power state, also called a core non-zero C-state (e.g., C1-C6 states), with each C-state being at a lower power consumption level (such that C6 is a deeper low power state than C1, and so forth).

Understand that many different types of power management techniques may be used individually or in combination in different embodiments. As representative examples, a power controller may control the processor to be power managed by some form of dynamic voltage frequency scaling (DVFS) in which an operating voltage and/or operating frequency of one or more cores or other processor logic may be dynamically controlled to reduce power consumption in certain situations. In an example, DVFS may be performed using Enhanced Intel SpeedStep™ technology available from Intel Corporation, Santa Clara, Calif., to provide optimal performance at a lowest power consumption level. In another example, DVFS may be performed using Intel TurboBoost™ technology to enable one or more cores or other compute engines to operate at a higher than guaranteed operating frequency based on conditions (e.g., workload and availability).

Another power management technique that may be used in certain examples is dynamic swapping of workloads between different compute engines. For example, the processor may include asymmetric cores or other processing engines that operate at different power consumption levels, such that in a power constrained situation, one or more workloads can be dynamically switched to execute on a lower power core or other compute engine. Another exemplary power management technique is hardware duty cycling (HDC), which may cause cores and/or other compute engines to be periodically enabled and disabled according to a duty cycle, such that one or more cores may be made inactive during an inactive period of the duty cycle and made active during an active period of the duty cycle.

Power management techniques also may be used when constraints exist in an operating environment. For example, when a power and/or thermal constraint is encountered, power may be reduced by reducing operating frequency and/or voltage. Other power management techniques include throttling instruction execution rate or limiting scheduling of instructions. Still further, it is possible for instructions of a given instruction set architecture to include express or implicit direction as to power management operations. Although described with these particular examples, understand that many other power management techniques may be used in particular embodiments.

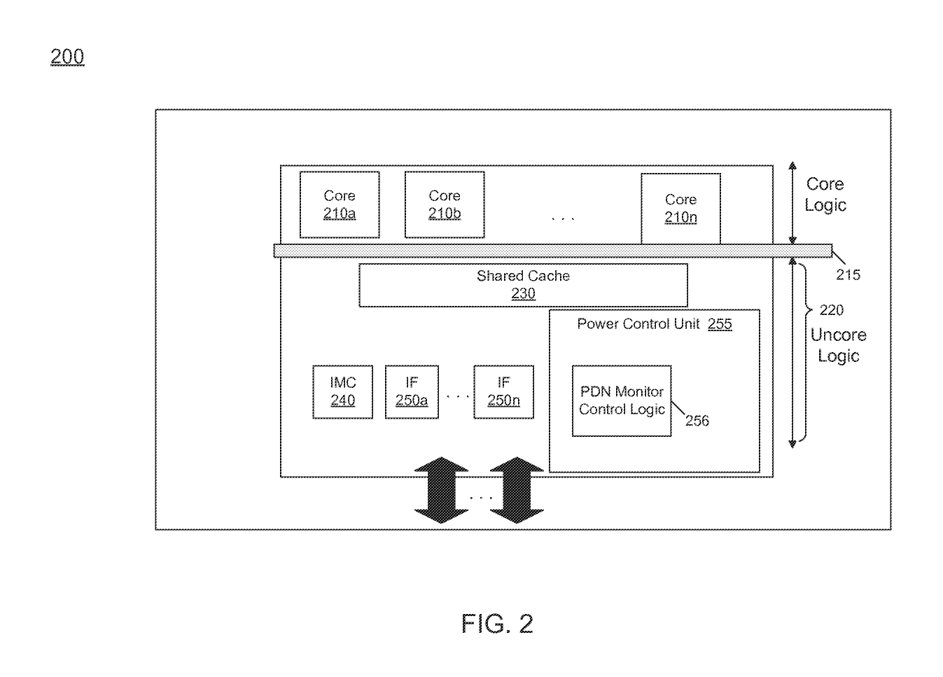

Embodiments can be implemented in processors for various markets including server processors, desktop processors, mobile processors and so forth. Referring now to FIG. 2, shown is a block diagram of a processor in accordance with an embodiment of the present invention. As shown in FIG. 2, processor 200 may be a multicore processor including a plurality of cores 210ₐ-210ₙ. In one embodiment, each such core may be of an independent power domain and can be configured to enter and exit active states and/or maximum performance states based on workload, and may include power monitoring circuitry as described herein. One or more cores 210 may be heterogeneous to the other cores, e.g., having different micro-architectures, instruction set architectures, pipeline depths, power and performance capabilities. The various cores may be coupled via an interconnect 215 to a system agent or uncore 220 that includes various components. As seen, the uncore 220 may include a shared cache 230 which may be a last level cache. In addition, the uncore may include an integrated memory controller 240 to communicate with a system memory (not shown in FIG. 2), e.g., via a memory bus. Uncore 220 also includes various interfaces 250 and a power control unit 255, which may include logic to perform the power management techniques described herein. To that end, FIG. 2 shows power control unit 255 including a PDN monitor control logic 256 which may include various circuitry to manage power-related delivery monitoring for the different cores and other domains of processor 200.

In addition, by interfaces 250a-250n, connection can be made to various off-chip components such as peripheral devices, mass storage and so forth. While shown with this particular implementation in the embodiment of FIG. 2, the scope of the present invention is not limited in this regard.

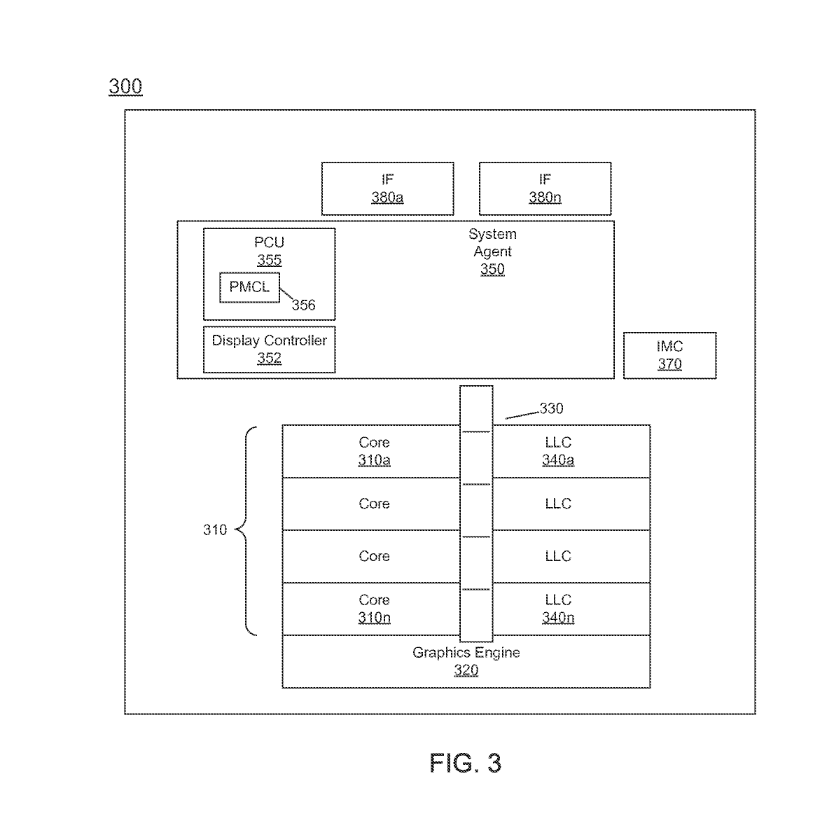

Referring now to FIG. 3, shown is a block diagram of a multi-domain processor in accordance with another embodiment of the present invention. As shown in the embodiment of FIG. 3, processor 300 includes multiple domains. Specifically, a core domain 310 can include a plurality of cores 310a-310n, a graphics domain 320 can include one or more graphics engines, and a system agent domain 350 may further be present. In some embodiments, system agent domain 350 may execute at an independent frequency than the core domain and may remain powered on at all times to handle power control events and power management such that domains 310 and 320 can be controlled to dynamically enter into and exit high power and low power states. Each of domains 310 and 320 may operate at different voltage and/or power, and may include power monitoring circuitry as described herein. Note that while only shown with three domains, understand the scope of the present invention is not limited in this regard and additional domains can be present in other embodiments. For example, multiple core domains may be present each including at least one core.

In general, each core 310 may further include low level caches in addition to various execution units and additional processing elements. In turn, the various cores may be coupled to each other and to a shared cache memory formed of a plurality of units of a last level cache (LLC) 340a-340n. In various embodiments, LLC 340 may be shared amongst the cores and the graphics engine, as well as various media processing circuitry. As seen, a ring interconnect 330 thus couples the cores together, and provides interconnection between the cores, graphics domain 320 and system agent circuitry 350. In one embodiment, interconnect 330 can be part of the core domain. However in other embodiments the ring interconnect can be of its own domain.

As further seen, system agent domain 350 may include display controller 352 which may provide control of and an interface to an associated display. As further seen, system agent domain 350 may include a power control unit 355 which can include logic to perform the power management techniques described herein, including a PDN monitor control logic 356 to control power monitoring circuitry of the various cores and other domains.

As further seen in FIG. 3, processor 300 can further include an integrated memory controller (IMC) 370 that can provide for an interface to a system memory, such as a dynamic random access memory (DRAM). Multiple interfaces 380a-380n may be present to enable interconnection between the processor and other circuitry. For example, in one embodiment at least one direct media interface (DMI) interface may be provided as well as one or more PCIe™ interfaces. Still further, to provide for communications between other agents such as additional processors or other circuitry, one or more QPI interfaces may also be provided. Although shown at this high level in the embodiment of FIG. 3, understand the scope of the present invention is not limited in this regard.

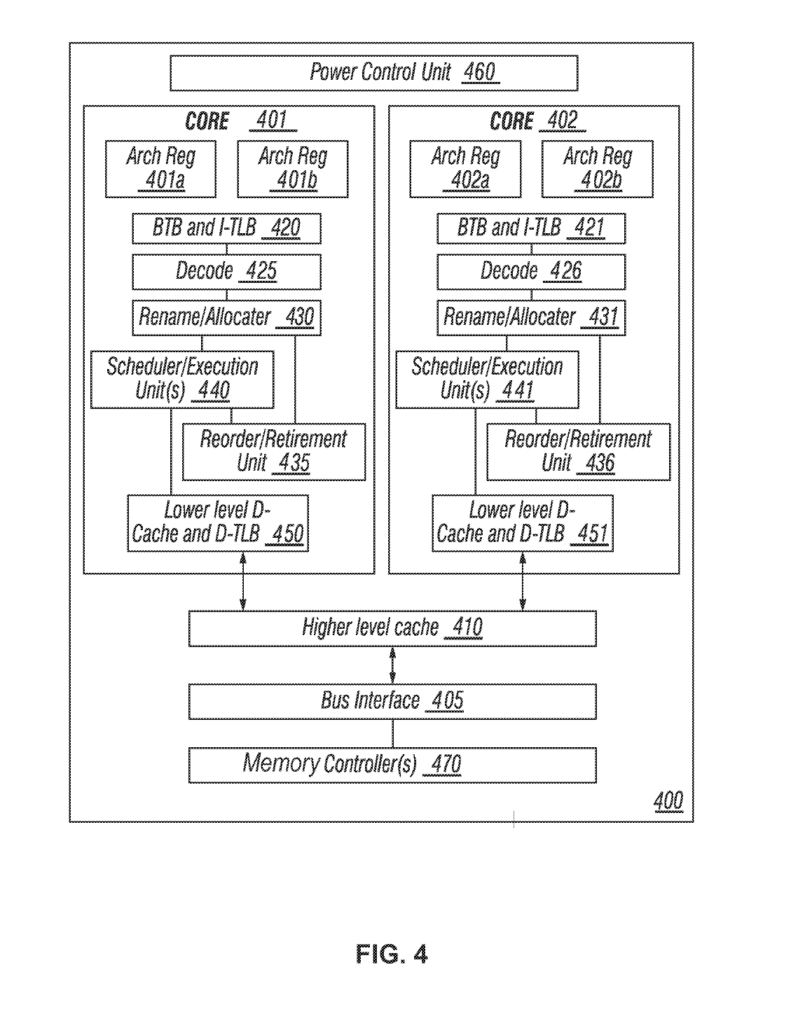

Referring to FIG. 4, an embodiment of a processor including multiple cores is illustrated. Processor 400 includes any processor or processing device, such as a microprocessor, an embedded processor, a digital signal processor (DSP), a network processor, a handheld processor, an application processor, a co-processor, a system on a chip (SoC), or other device to execute code. Processor 400, in one embodiment, includes at least two cores—cores 401 and 402, which may include asymmetric cores or symmetric cores (the illustrated embodiment). However, processor 400 may include any number of processing elements that may be symmetric or asymmetric.

In one embodiment, a processing element refers to hardware or logic to support a software thread. Examples of hardware processing elements include: a thread unit, a thread slot, a thread, a process unit, a context, a context unit, a logical processor, a hardware thread, a core, and/or any other element, which is capable of holding a state for a processor, such as an execution state or architectural state. In other words, a processing element, in one embodiment, refers to any hardware capable of being independently associated with code, such as a software thread, operating system, application, or other code. A physical processor typically refers to an integrated circuit, which potentially includes any number of other processing elements, such as cores or hardware threads.

A core often refers to logic located on an integrated circuit capable of maintaining an independent architectural state, wherein each independently maintained architectural state is associated with at least some dedicated execution resources. In contrast to cores, a hardware thread typically refers to any logic located on an integrated circuit capable of maintaining an independent architectural state, wherein the independently maintained architectural states share access to execution resources. As can be seen, when certain resources are shared and others are dedicated to an architectural state, the line between the nomenclature of a hardware thread and core overlaps. Yet often, a core and a hardware thread are viewed by an operating system as individual logical processors, where the operating system is able to individually schedule operations on each logical processor.

Physical processor 400, as illustrated in FIG. 4, includes two cores, cores 401 and 402. Here, cores 401 and 402 are considered symmetric cores, i.e., cores with the same configurations, functional units, and/or logic. In another embodiment, core 401 includes an out-of-order processor core, while core 402 includes an in-order processor core. However, cores 401 and 402 may be individually selected from any type of core, such as a native core, a software managed core, a core adapted to execute a native instruction set architecture (ISA), a core adapted to execute a translated ISA, a co-designed core, or other known core. Yet to further the discussion, the functional units illustrated in core 401 are described in further detail below, as the units in core 402 operate in a similar manner.

As depicted, core 401 includes two hardware threads 401a and 401b, which may also be referred to as hardware thread slots 401a and 401b. Therefore, software entities, such as an operating system, in one embodiment potentially view processor 400 as four separate processors, i.e., four logical processors or processing elements capable of executing four software threads concurrently. As alluded to above, a first thread is associated with architecture state registers 401a, a second thread is associated with architecture state registers 401b, a third thread may be associated with architecture state registers 402a, and a fourth thread may be associated with architecture state registers 402b. Here, each of the architecture state registers (401a, 401b, 402a, and 402b) may be referred to as processing elements, thread slots, or thread units, as described above. As illustrated, architecture state registers 401a are replicated in architecture state registers 401b, so individual architecture states/contexts are capable of being stored for logical processor 401a and logical processor 401b. In core 401, other smaller resources, such as instruction pointers and renaming logic in allocator and renamer block 430 may also be replicated for threads 401a and 401b. Some resources, such as re-order buffers in reorder/retirement unit 435, branch target buffer and instruction translation lookaside buffer (BTB and I-TLB) 420, load/store buffers, and queues may be shared through partitioning. Other resources, such as general purpose internal registers, page-table base register(s), low-level data-cache and data-TLB 450, execution unit(s) 440, and portions of out-of-order unit 435 are potentially fully shared.

Processor 400 often includes other resources, which may be fully shared, shared through partitioning, or dedicated by/to processing elements. In FIG. 4, an embodiment of a purely exemplary processor with illustrative logical units/resources of a processor is illustrated. Note that a processor may include, or omit, any of these functional units, as well as include any other known functional units, logic, or firmware not depicted. As illustrated, core 401 includes a simplified, representative out-of-order (OOO) processor core. But an in-order processor may be utilized in different embodiments. The OOO core includes a branch target buffer 420 to predict branches to be executed/taken and an instruction-translation buffer (I-TLB) 420 to store address translation entries for instructions.

Core 401 further includes decode module 425 coupled to a fetch unit to decode fetched elements. Fetch logic, in one embodiment, includes individual sequencers associated with thread slots 401a, 401b, respectively. Usually core 401 is associated with a first ISA, which defines/specifies instructions executable on processor 400. Often machine code instructions that are part of the first ISA include a portion of the instruction (referred to as an opcode), which references/specifies an instruction or operation to be performed. Decode logic 425 includes circuitry that recognizes these instructions from their opcodes and passes the decoded instructions on in the pipeline for processing as defined by the first ISA. For example, decoders 425, in one embodiment, include logic designed or adapted to recognize specific instructions, such as transactional instruction. As a result of the recognition by decoders 425, the architecture or core 401 takes specific, predefined actions to perform tasks associated with the appropriate instruction. It is important to note that any of the tasks, blocks, operations, and methods described herein may be performed in response to a single or multiple instructions; some of which may be new or old instructions.

In one example, allocator and renamer block 430 includes an allocator to reserve resources, such as register files to store instruction processing results. However, threads 401a and 401b are potentially capable of out-of-order execution, where allocator and renamer block 430 also reserves other resources, such as reorder buffers to track instruction results. Unit 430 may also include a register renamer to rename program/instruction reference registers to other registers internal to processor 400. Reorder/retirement unit 435 includes components, such as the reorder buffers mentioned above, load buffers, and store buffers, to support out-of-order execution and later in-order retirement of instructions executed out-of-order.

Scheduler and execution unit(s) block 440, in one embodiment, includes a scheduler unit to schedule instructions/operation on execution units. For example, a floating point instruction is scheduled on a port of an execution unit that has an available floating point execution unit. Register files associated with the execution units are also included to store information instruction processing results. Exemplary execution units include a floating point execution unit, an integer execution unit, a jump execution unit, a load execution unit, a store execution unit, and other known execution units.

Lower level data cache and data translation lookaside buffer (D-TLB) 450 are coupled to execution unit(s) 440. The data cache is to store recently used/operated on elements, such as data operands, which are potentially held in memory coherency states. The D-TLB is to store recent virtual/linear to physical address translations. As a specific example, a processor may include a page table structure to break physical memory into a plurality of virtual pages.

Here, cores 401 and 402 share access to higher-level or further-out cache 410, which is to cache recently fetched elements. Note that higher-level or further-out refers to cache levels increasing or getting further away from the execution unit(s). In one embodiment, higher-level cache 410 is a last-level data cache—last cache in the memory hierarchy on processor 400—such as a second or third level data cache. However, higher level cache 410 is not so limited, as it may be associated with or includes an instruction cache. A trace cache—a type of instruction cache—instead may be coupled after decoder 425 to store recently decoded traces.

In the depicted configuration, processor 400 also includes bus interface module 405 and a power control unit 460, which may perform power management in accordance with an embodiment of the present invention. In this scenario, bus interface 405 is to communicate with devices external to processor 400, such as system memory and other components.

A memory controller 470 may interface with other devices such as one or many memories. In an example, bus interface 405 includes a ring interconnect with a memory controller for interfacing with a memory and a graphics controller for interfacing with a graphics processor. In an SoC environment, even more devices, such as a network interface, coprocessors, memory, graphics processor, and any other known computer devices/interface may be integrated on a single die or integrated circuit to provide small form factor with high functionality and low power consumption.

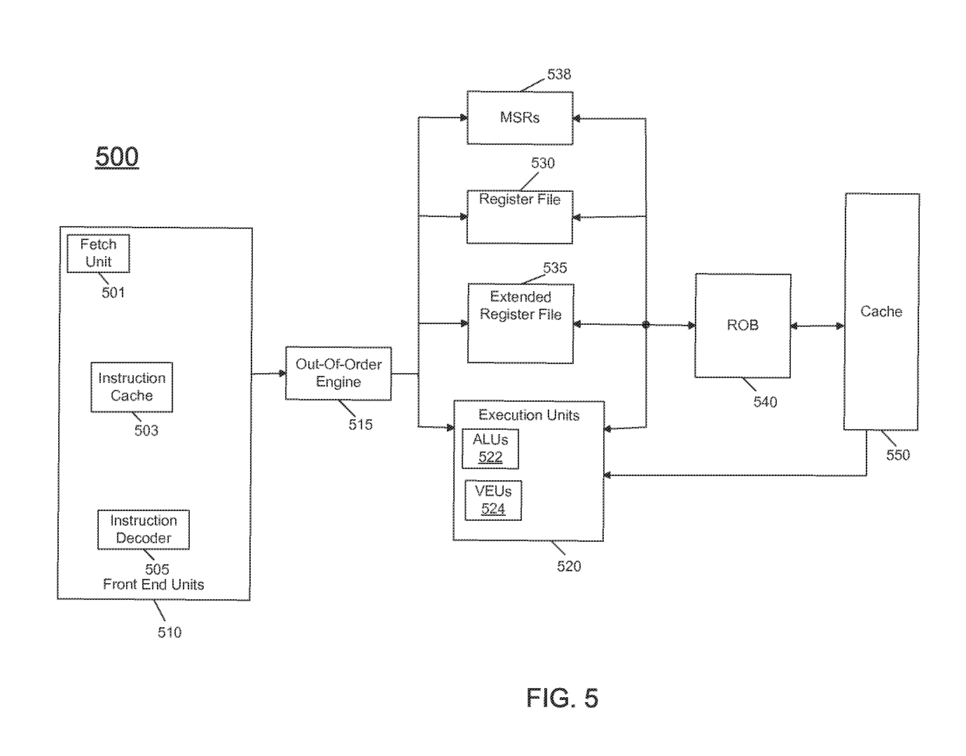

Referring now to FIG. 5, shown is a block diagram of a micro-architecture of a processor core in accordance with one embodiment of the present invention. As shown in FIG. 5, processor core 500 may be a multi-stage pipelined out-of-order processor. Core 500 may operate at various voltages based on a received operating voltage, which may be received from an integrated voltage regulator or external voltage regulator.

As seen in FIG. 5, core 500 includes front end units 510, which may be used to fetch instructions to be executed and prepare them for use later in the processor pipeline. For example, front end units 510 may include a fetch unit 501, an instruction cache 503, and an instruction decoder 505. In some implementations, front end units 510 may further include a trace cache, along with microcode storage as well as a micro-operation storage. Fetch unit 501 may fetch macro-instructions, e.g., from memory or instruction cache 503, and feed them to instruction decoder 505 to decode them into primitives, i.e., micro-operations for execution by the processor.

Coupled between front end units 510 and execution units 520 is an out-of-order (OOO) engine 515 that may be used to receive the micro-instructions and prepare them for execution. More specifically OOO engine 515 may include various buffers to re-order micro-instruction flow and allocate various resources needed for execution, as well as to provide renaming of logical registers onto storage locations within various register files such as register file 530 and extended register file 535. Register file 530 may include separate register files for integer and floating point operations. For purposes of configuration, control, and additional operations, a set of machine specific registers (MSRs) 538 may also be present and accessible to various logic within core 500 (and external to the core). For example, power limit information may be stored in one or more MSR and be dynamically updated as described herein.

Various resources may be present in execution units 520, including, for example, various integer, floating point, and single instruction multiple data (SIMD) logic units, among other specialized hardware. For example, such execution units may include one or more arithmetic logic units (ALUs) 522 and one or more vector execution units 524, among other such execution units.

Results from the execution units may be provided to retirement logic, namely a reorder buffer (ROB) 540. More specifically, ROB 540 may include various arrays and logic to receive information associated with instructions that are executed. This information is then examined by ROB 540 to determine whether the instructions can be validly retired and result data committed to the architectural state of the processor, or whether one or more exceptions occurred that prevent a proper retirement of the instructions. Of course, ROB 540 may handle other operations associated with retirement.

As shown in FIG. 5, ROB 540 is coupled to a cache 550 which, in one embodiment may be a low level cache (e.g., an L1 cache) although the scope of the present invention is not limited in this regard. Also, execution units 520 can be directly coupled to cache 550. From cache 550, data communication may occur with higher level caches, system memory and so forth. While shown with this high level in the embodiment of FIG. 5, understand the scope of the present invention is not limited in this regard. For example, while the implementation of FIG. 5 is with regard to an out-of-order machine such as of an Intel® x86 instruction set architecture (ISA), the scope of the present invention is not limited in this regard. That is, other embodiments may be implemented in an in-order processor, a reduced instruction set computing (RISC) processor such as an ARM-based processor, or a processor of another type of ISA that can emulate instructions and operations of a different ISA via an emulation engine and associated logic circuitry.

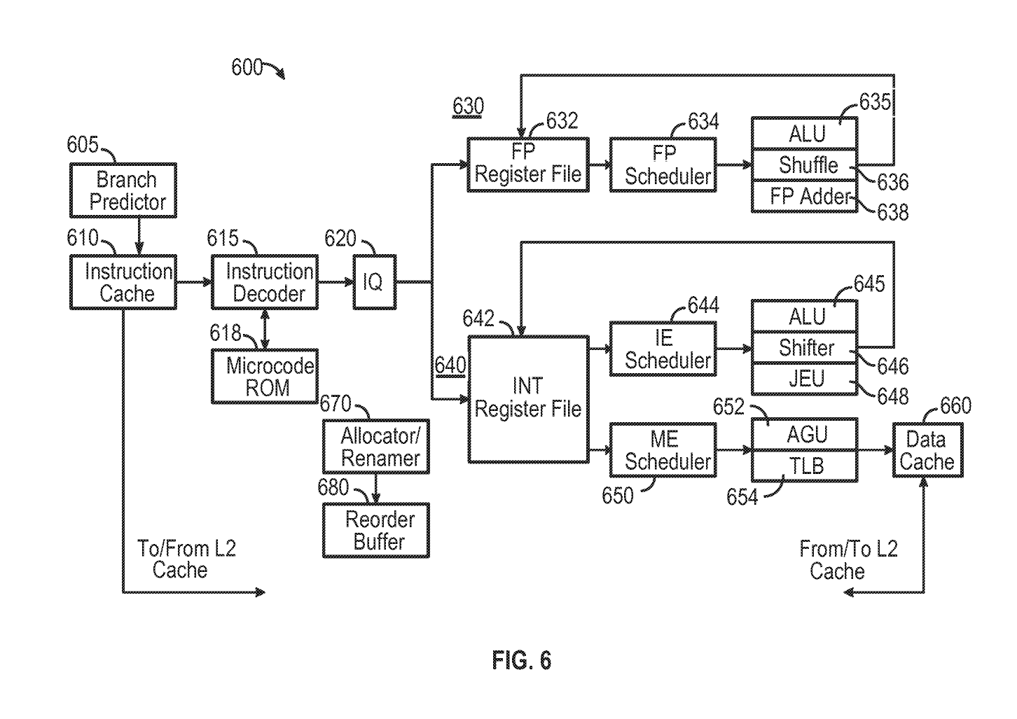

Referring now to FIG. 6, shown is a block diagram of a micro-architecture of a processor core in accordance with another embodiment. In the embodiment of FIG. 6, core 600 may be a low power core of a different micro-architecture, such as an Intel® Atom™-based processor having a relatively limited pipeline depth designed to reduce power consumption. As seen, core 600 includes an instruction cache 610 coupled to provide instructions to an instruction decoder 615. A branch predictor 605 may be coupled to instruction cache 610. Note that instruction cache 610 may further be coupled to another level of a cache memory, such as an L2 cache (not shown for ease of illustration in FIG. 6). In turn, instruction decoder 615 provides decoded instructions to an issue queue (IQ) 620 for storage and delivery to a given execution pipeline. A microcode ROM 618 is coupled to instruction decoder 615.

A floating point pipeline 630 includes a floating point (FP) register file 632 which may include a plurality of architectural registers of a given bit with such as 128, 256 or 512 bits. Pipeline 630 includes a floating point scheduler 634 to schedule instructions for execution on one of multiple execution units of the pipeline. In the embodiment shown, such execution units include an ALU 635, a shuffle unit 636, and a floating point adder 638. In turn, results generated in these execution units may be provided back to buffers and/or registers of register file 632. Of course understand while shown with these few example execution units, additional or different floating point execution units may be present in another embodiment.

An integer pipeline 640 also may be provided. In the embodiment shown, pipeline 640 includes an integer (INT) register file 642 which may include a plurality of architectural registers of a given bit with such as 128 or 256 bits. Pipeline 640 includes an integer execution (IE) scheduler 644 to schedule instructions for execution on one of multiple execution units of the pipeline. In the embodiment shown, such execution units include an ALU 645, a shifter unit 646, and a jump execution unit (JEU) 648. In turn, results generated in these execution units may be provided back to buffers and/or registers of register file 642. Of course understand while shown with these few example execution units, additional or different integer execution units may be present in another embodiment.

A memory execution (ME) scheduler 650 may schedule memory operations for execution in an address generation unit (AGU) 652, which is also coupled to a TLB 654. As seen, these structures may couple to a data cache 660, which may be a L0 and/or L1 data cache that in turn couples to additional levels of a cache memory hierarchy, including an L2 cache memory.

To provide support for out-of-order execution, an allocator/renamer 670 may be provided, in addition to a reorder buffer 680, which is configured to reorder instructions executed out of order for retirement in order. Although shown with this particular pipeline architecture in the illustration of FIG. 6, understand that many variations and alternatives are possible.

Note that in a processor having asymmetric cores, such as in accordance with the micro-architectures of FIGS. 5 and 6, workloads may be dynamically swapped between the cores for power management reasons, as these cores, although having different pipeline designs and depths, may be of the same or related ISA. Such dynamic core swapping may be performed in a manner transparent to a user application (and possibly kernel also).

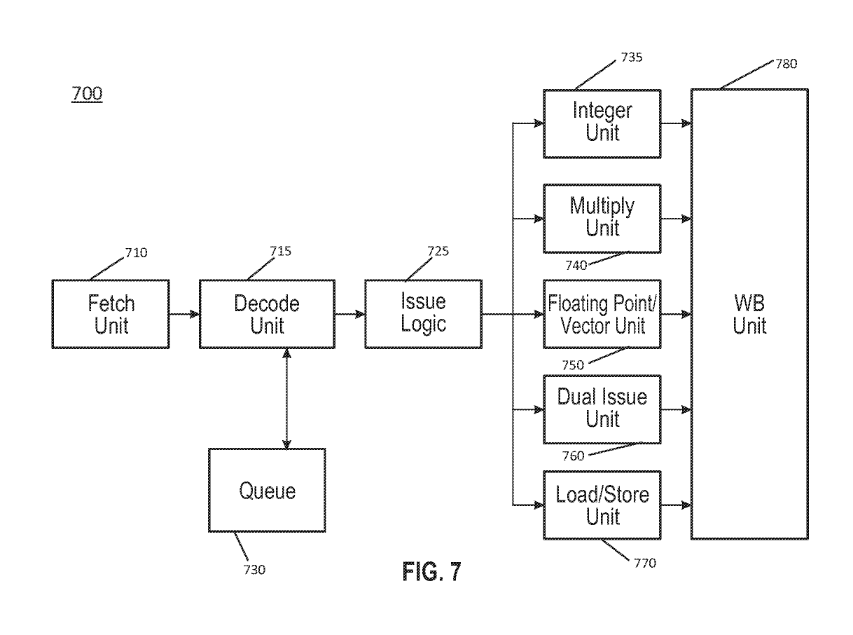

Referring to FIG. 7, shown is a block diagram of a micro-architecture of a processor core in accordance with yet another embodiment. As illustrated in FIG. 7, a core 700 may include a multi-staged in-order pipeline to execute at very low power consumption levels. As one such example, processor 700 may have a micro-architecture in accordance with an ARM Cortex A53 design available from ARM Holdings, LTD., Sunnyvale, Calif. In an implementation, an 8-stage pipeline may be provided that is configured to execute both 32-bit and 64-bit code. Core 700 includes a fetch unit 710 that is configured to fetch instructions and provide them to a decode unit 715, which may decode the instructions, e.g., macro-instructions of a given ISA such as an ARMv8 ISA. Note further that a queue 730 may couple to decode unit 715 to store decoded instructions. Decoded instructions are provided to an issue logic 725, where the decoded instructions may be issued to a given one of multiple execution units.

With further reference to FIG. 7, issue logic 725 may issue instructions to one of multiple execution units. In the embodiment shown, these execution units include an integer unit 735, a multiply unit 740, a floating point/vector unit 750, a dual issue unit 760, and a load/store unit 770. The results of these different execution units may be provided to a writeback (WB) unit 780. Understand that while a single writeback unit is shown for ease of illustration, in some implementations separate writeback units may be associated with each of the execution units. Furthermore, understand that while each of the units and logic shown in FIG. 7 is represented at a high level, a particular implementation may include more or different structures. A processor designed using one or more cores having a pipeline as in FIG. 7 may be implemented in many different end products, extending from mobile devices to server systems.

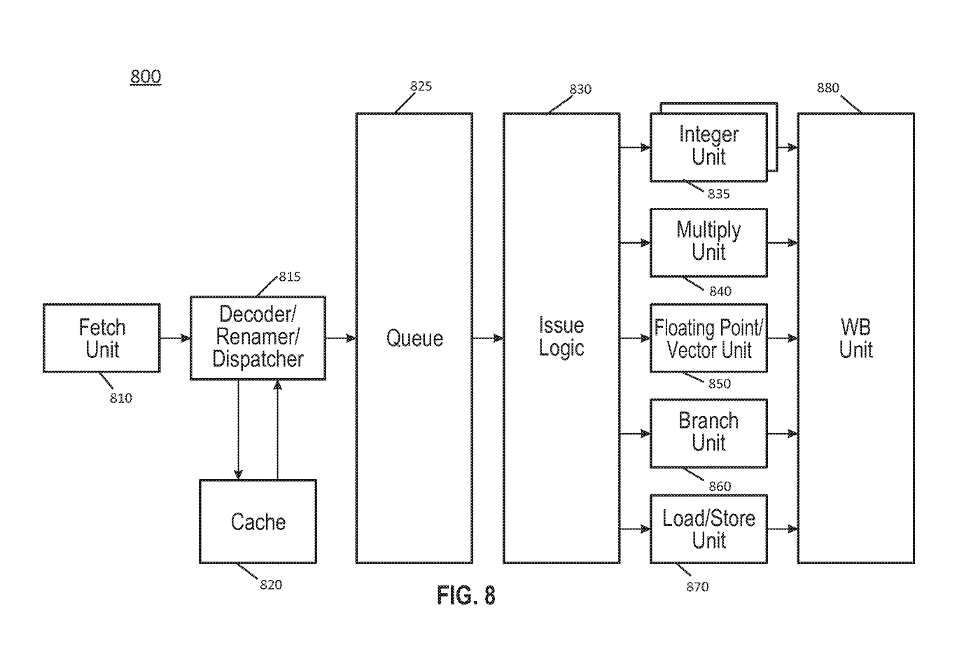

Referring to FIG. 8, shown is a block diagram of a micro-architecture of a processor core in accordance with a still further embodiment. As illustrated in FIG. 8, a core 800 may include a multi-stage multi-issue out-of-order pipeline to execute at very high performance levels (which may occur at higher power consumption levels than core 700 of FIG. 7). As one such example, processor 800 may have a microarchitecture in accordance with an ARM Cortex A57 design. In an implementation, a 15 (or greater)-stage pipeline may be provided that is configured to execute both 32-bit and 64-bit code. In addition, the pipeline may provide for 3 (or greater)-wide and 3 (or greater)-issue operation. Core 800 includes a fetch unit 810 that is configured to fetch instructions and provide them to a decoder/renamer/dispatcher unit 815 coupled to a cache 820. Unit 815 may decode the instructions, e.g., macro-instructions of an ARMv8 instruction set architecture, rename register references within the instructions, and dispatch the instructions (eventually) to a selected execution unit. Decoded instructions may be stored in a queue 825. Note that while a single queue structure is shown for ease of illustration in FIG. 8, understand that separate queues may be provided for each of the multiple different types of execution units.

Also shown in FIG. 8 is an issue logic 830 from which decoded instructions stored in queue 825 may be issued to a selected execution unit. Issue logic 830 also may be implemented in a particular embodiment with a separate issue logic for each of the multiple different types of execution units to which issue logic 830 couples.

Decoded instructions may be issued to a given one of multiple execution units. In the embodiment shown, these execution units include one or more integer units 835, a multiply unit 840, a floating point/vector unit 850, a branch unit 860, and a load/store unit 870. In an embodiment, floating point/vector unit 850 may be configured to handle SIMD or vector data of 128 or 256 bits. Still further, floating point/vector execution unit 850 may perform IEEE-754 double precision floating-point operations. The results of these different execution units may be provided to a writeback unit 880. Note that in some implementations separate writeback units may be associated with each of the execution units. Furthermore, understand that while each of the units and logic shown in FIG. 8 is represented at a high level, a particular implementation may include more or different structures.

Note that in a processor having asymmetric cores, such as in accordance with the micro-architectures of FIGS. 7 and 8, workloads may be dynamically swapped for power management reasons, as these cores, although having different pipeline designs and depths, may be of the same or related ISA. Such dynamic core swapping may be performed in a manner transparent to a user application (and possibly kernel also).

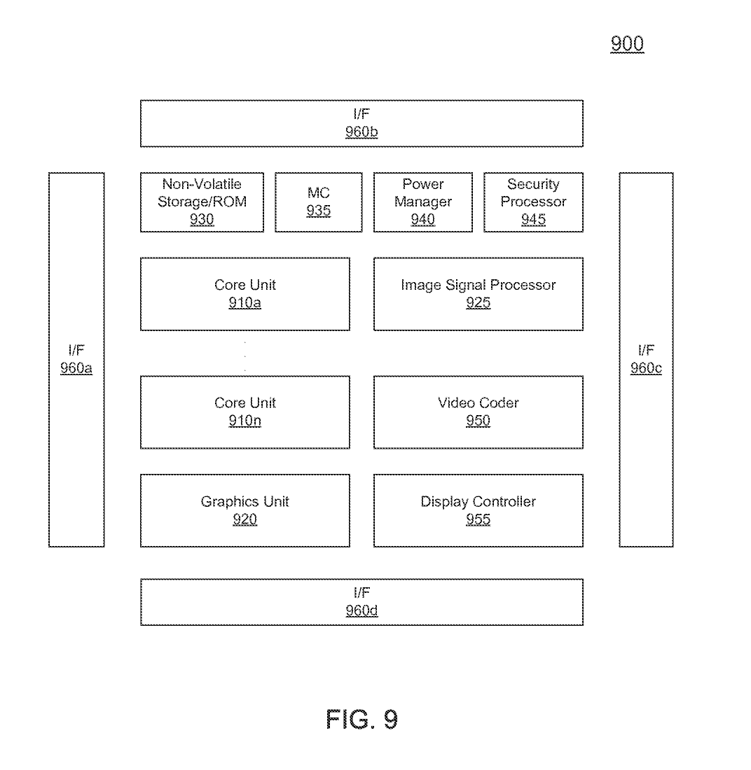

A processor designed using one or more cores having pipelines as in any one or more of FIGS. 5-8 may be implemented in many different end products, extending from mobile devices to server systems. Referring now to FIG. 9, shown is a block diagram of a processor in accordance with another embodiment of the present invention. In the embodiment of FIG. 9, processor 900 may be a SoC including multiple domains, each of which may be controlled to operate at an independent operating voltage and operating frequency. As a specific illustrative example, processor 900 may be an Intel® Architecture Core™-based processor such as an i3, i5, i7 or another such processor available from Intel Corporation. However, other low power processors such as available from Advanced Micro Devices, Inc. (AMD) of Sunnyvale, Calif., an ARM-based design from ARM Holdings, Ltd. or licensee thereof or a MIPS-based design from MIPS Technologies, Inc. of Sunnyvale, Calif., or their licensees or adopters may instead be present in other embodiments such as an Apple A7 processor, a Qualcomm Snapdragon processor, or Texas Instruments OMAP processor. Such SoC may be used in a low power system such as a smartphone, tablet computer, phablet computer, Ultrabook™ computer or other portable computing device, which may incorporate a heterogeneous system architecture having a heterogeneous system architecture-based processor design.

In the high level view shown in FIG. 9, processor 900 includes a plurality of core units 910a-910n. Each core unit may include one or more processor cores, one or more cache memories and other circuitry. Each core unit 910 may support one or more instruction sets (e.g., an x86 instruction set (with some extensions that have been added with newer versions); a MIPS instruction set; an ARM instruction set (with optional additional extensions such as NEON)) or other instruction set or combinations thereof. Note that some of the core units may be heterogeneous resources (e.g., of a different design). In addition, each such core may be coupled to a cache memory (not shown) which in an embodiment may be a shared level two (L2) cache memory. A non-volatile storage 930 may be used to store various program and other data. For example, this storage may be used to store at least portions of microcode, boot information such as a BIOS, other system software or so forth.

Each core unit 910 may also include an interface such as a bus interface unit to enable interconnection to additional circuitry of the processor. In an embodiment, each core unit 910 couples to a coherent fabric that may act as a primary cache coherent on-die interconnect that in turn couples to a memory controller 935. In turn, memory controller 935 controls communications with a memory such as a DRAM (not shown for ease of illustration in FIG. 9).

In addition to core units, additional processing engines are present within the processor, including at least one graphics unit 920 which may include one or more graphics processing units (GPUs) to perform graphics processing as well as to possibly execute general purpose operations on the graphics processor (so-called GPGPU operation). In addition, at least one image signal processor 925 may be present. Signal processor 925 may be configured to process incoming image data received from one or more capture devices, either internal to the SoC or off-chip.

Other accelerators also may be present. In the illustration of FIG. 9, a video coder 950 may perform coding operations including encoding and decoding for video information, e.g., providing hardware acceleration support for high definition video content. A display controller 955 further may be provided to accelerate display operations including providing support for internal and external displays of a system. In addition, a security processor 945 may be present to perform security operations such as secure boot operations, various cryptography operations and so forth.

Each of the units may have its power consumption controlled via a power manager 940, which may include control logic to perform the various power management techniques described herein.

In some embodiments, SoC 900 may further include a non-coherent fabric coupled to the coherent fabric to which various peripheral devices may couple. One or more interfaces 960a-960d enable communication with one or more off-chip devices. Such communications may be via a variety of communication protocols such as PCIe™, GPIO, USB, I²C, UART, MIPI, SDIO, DDR, SPI, HDMI, among other types of communication protocols. Although shown at this high level in the embodiment of FIG. 9, understand the scope of the present invention is not limited in this regard.

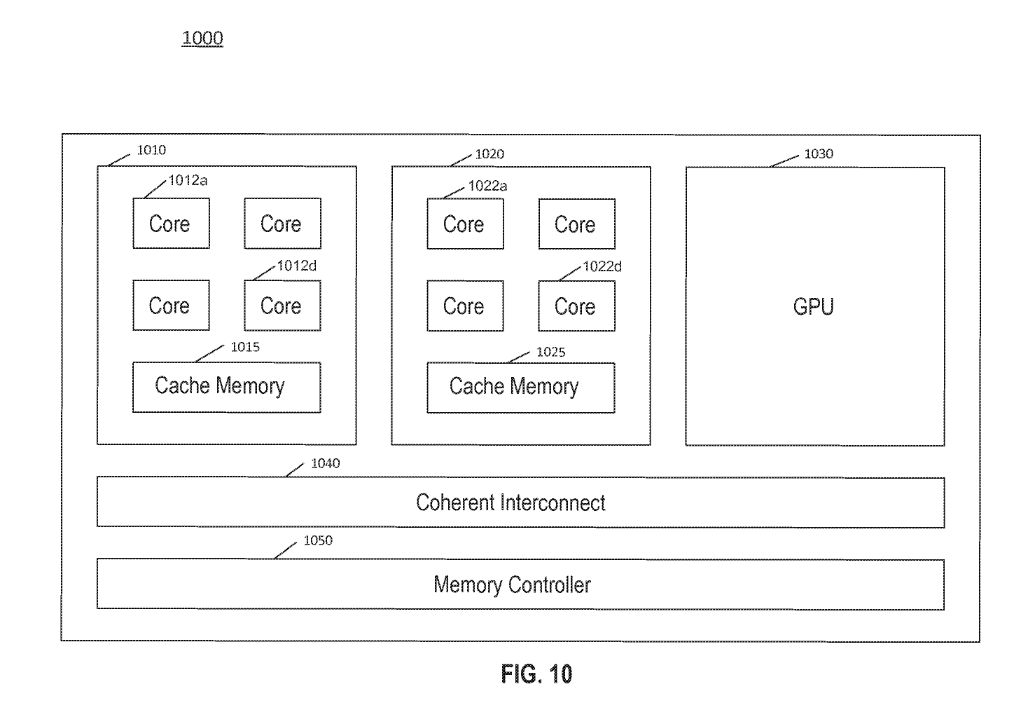

Referring now to FIG. 10, shown is a block diagram of a representative SoC. In the embodiment shown, SoC 1000 may be a multi-core SoC configured for low power operation to be optimized for incorporation into a smartphone or other low power device such as a tablet computer or other portable computing device. As an example, SoC 1000 may be implemented using asymmetric or different types of cores, such as combinations of higher power and/or low power cores, e.g., out-of-order cores and in-order cores. In different embodiments, these cores may be based on an Intel® Architecture™ core design or an ARM architecture design. In yet other embodiments, a mix of Intel and ARM cores may be implemented in a given SoC.

As seen in FIG. 10, SoC 1000 includes a first core domain 1010 having a plurality of first cores 1012a-1012d. In an example, these cores may be low power cores such as in-order cores. In one embodiment these first cores may be implemented as ARM Cortex A53 cores. In turn, these cores couple to a cache memory 1015 of core domain 1010. In addition, SoC 1000 includes a second core domain 1020. In the illustration of FIG. 10, second core domain 1020 has a plurality of second cores 1022a-1022d. In an example, these cores may be higher power-consuming cores than first cores 1012. In an embodiment, the second cores may be out-of-order cores, which may be implemented as ARM Cortex A57 cores. In turn, these cores couple to a cache memory 1025 of core domain 1020. Note that while the example shown in FIG. 10 includes 4 cores in each domain, understand that more or fewer cores may be present in a given domain in other examples.

With further reference to FIG. 10, a graphics domain 1030 also is provided, which may include one or more graphics processing units (GPUs) configured to independently execute graphics workloads, e.g., provided by one or more cores of core domains 1010 and 1020. As an example, GPU domain 1030 may be used to provide display support for a variety of screen sizes, in addition to providing graphics and display rendering operations.

As seen, the various domains couple to a coherent interconnect 1040, which in an embodiment may be a cache coherent interconnect fabric that in turn couples to an integrated memory controller 1050. Coherent interconnect 1040 may include a shared cache memory, such as an L3 cache, in some examples. In an embodiment, memory controller 1050 may be a direct memory controller to provide for multiple channels of communication with an off-chip memory, such as multiple channels of a DRAM (not shown for ease of illustration in FIG. 10).

In different examples, the number of the core domains may vary. For example, for a low power SoC suitable for incorporation into a mobile computing device, a limited number of core domains such as shown in FIG. 10 may be present. Still further, in such low power SoCs, core domain 1020 including higher power cores may have fewer numbers of such cores. For example, in one implementation two cores 1022 may be provided to enable operation at reduced power consumption levels. In addition, the different core domains may also be coupled to an interrupt controller to enable dynamic swapping of workloads between the different domains.

In yet other embodiments, a greater number of core domains, as well as additional optional IP logic may be present, in that an SoC can be scaled to higher performance (and power) levels for incorporation into other computing devices, such as desktops, servers, high performance computing systems, base stations forth. As one such example, 4 core domains each having a given number of out-of-order cores may be provided. Still further, in addition to optional GPU support (which as an example may take the form of a GPGPU), one or more accelerators to provide optimized hardware support for particular functions (e.g. web serving, network processing, switching or so forth) also may be provided. In addition, an input/output interface may be present to couple such accelerators to off-chip components.

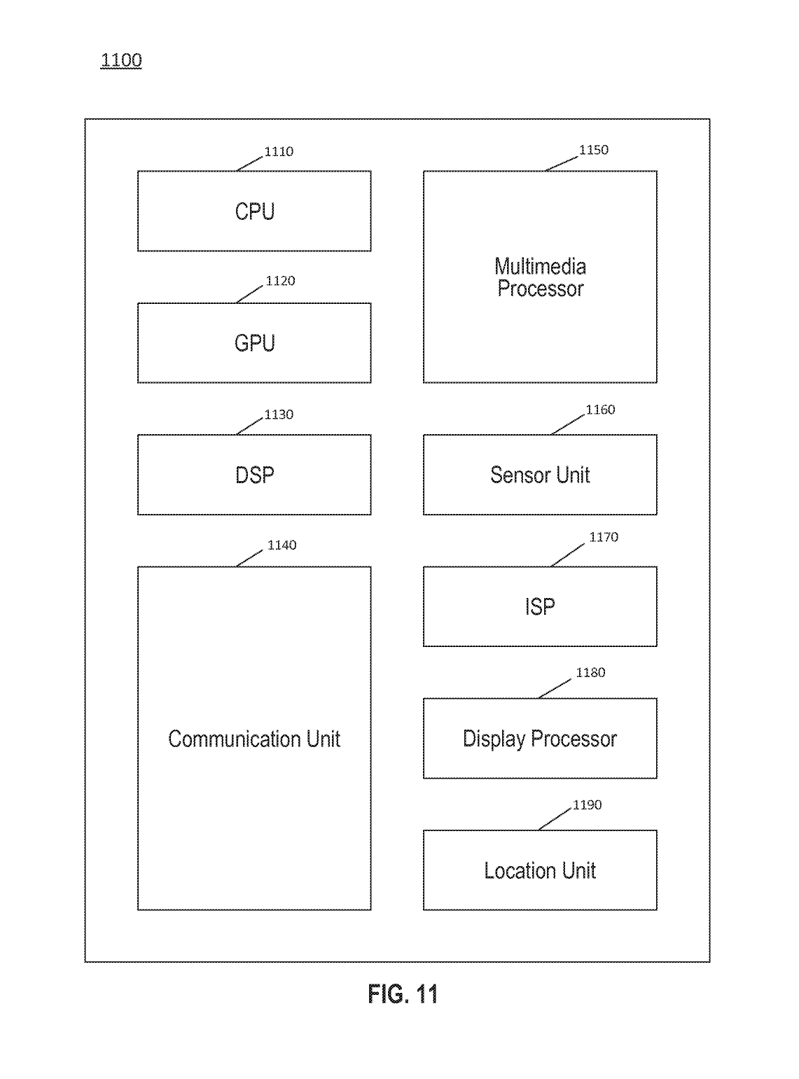

Referring now to FIG. 11, shown is a block diagram of another example SoC. In the embodiment of FIG. 11, SoC 1100 may include various circuitry to enable high performance for multimedia applications, communications and other functions. As such, SoC 1100 is suitable for incorporation into a wide variety of portable and other devices, such as smartphones, tablet computers, smart TVs and so forth. In the example shown, SoC 1100 includes a central processor unit (CPU) domain 1110. In an embodiment, a plurality of individual processor cores may be present in CPU domain 1110. As one example, CPU domain 1110 may be a quad core processor having 4 multithreaded cores. Such processors may be homogeneous or heterogeneous processors, e.g., a mix of low power and high power processor cores.

In turn, a GPU domain 1120 is provided to perform advanced graphics processing in one or more GPUs to handle graphics and compute APIs. A DSP unit 1130 may provide one or more low power DSPs for handling low-power multimedia applications such as music playback, audio/video and so forth, in addition to advanced calculations that may occur during execution of multimedia instructions. In turn, a communication unit 1140 may include various components to provide connectivity via various wireless protocols, such as cellular communications (including 3G/4G LTE), wireless local area protocols such as Bluetooth™, IEEE 802.11, and so forth.

Still further, a multimedia processor 1150 may be used to perform capture and playback of high definition video and audio content, including processing of user gestures. A sensor unit 1160 may include a plurality of sensors and/or a sensor controller to interface to various off-chip sensors present in a given platform. An image signal processor 1170 may be provided with one or more separate ISPs to perform image processing with regard to captured content from one or more cameras of a platform, including still and video cameras.

A display processor 1180 may provide support for connection to a high definition display of a given pixel density, including the ability to wirelessly communicate content for playback on such display. Still further, a location unit 1190 may include a GPS receiver with support for multiple GPS constellations to provide applications highly accurate positioning information obtained using as such GPS receiver. Understand that while shown with this particular set of components in the example of FIG. 11, many variations and alternatives are possible.

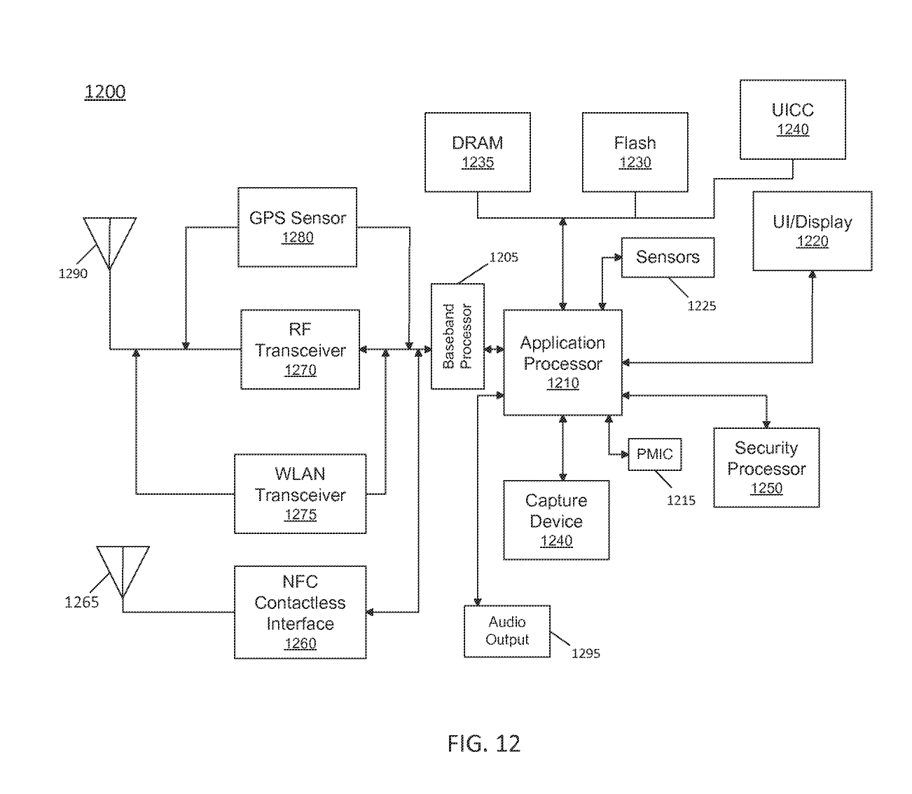

Referring now to FIG. 12, shown is a block diagram of an example system with which embodiments can be used. As seen, system 1200 may be a smartphone or other wireless communicator. A baseband processor 1205 is configured to perform various signal processing with regard to communication signals to be transmitted from or received by the system. In turn, baseband processor 1205 is coupled to an application processor 1210, which may be a main CPU of the system to execute an OS and other system software, in addition to user applications such as many well-known social media and multimedia apps. Application processor 1210 may further be configured to perform a variety of other computing operations for the device.

In turn, application processor 1210 can couple to a user interface/display 1220, e.g., a touch screen display. In addition, application processor 1210 may couple to a memory system including a non-volatile memory, namely a flash memory 1230 and a system memory, namely a dynamic random access memory (DRAM) 1235. As further seen, application processor 1210 further couples to a capture device 1240 such as one or more image capture devices that can record video and/or still images.

Still referring to FIG. 12, a universal integrated circuit card (UICC) 1240 comprising a subscriber identity module and possibly a secure storage and cryptoprocessor is also coupled to application processor 1210. System 1200 may further include a security processor 1250 that may couple to application processor 1210. A plurality of sensors 1225 may couple to application processor 1210 to enable input of a variety of sensed information such as accelerometer and other environmental information. An audio output device 1295 may provide an interface to output sound, e.g., in the form of voice communications, played or streaming audio data and so forth.

As further illustrated, a near field communication (NFC) contactless interface 1260 is provided that communicates in a NFC near field via an NFC antenna 1265. While separate antennae are shown in FIG. 12, understand that in some implementations one antenna or a different set of antennae may be provided to enable various wireless functionality.

A power management integrated circuit (PMIC) 1215 couples to application processor 1210 to perform platform level power management. To this end, PMIC 1215 may issue power management requests to application processor 1210 to enter certain low power states as desired. Furthermore, based on platform constraints, PMIC 1215 may also control the power level of other components of system 1200.

To enable communications to be transmitted and received, various circuitry may be coupled between baseband processor 1205 and an antenna 1290. Specifically, a radio frequency (RF) transceiver 1270 and a wireless local area network (WLAN) transceiver 1275 may be present. In general, RF transceiver 1270 may be used to receive and transmit wireless data and calls according to a given wireless communication protocol such as 3G or 4G wireless communication protocol such as in accordance with a code division multiple access (CDMA), global system for mobile communication (GSM), long term evolution (LTE) or other protocol. In addition a GPS sensor 1280 may be present. Other wireless communications such as receipt or transmission of radio signals, e.g., AM/FM and other signals may also be provided. In addition, via WLAN transceiver 1275, local wireless communications can also be realized.

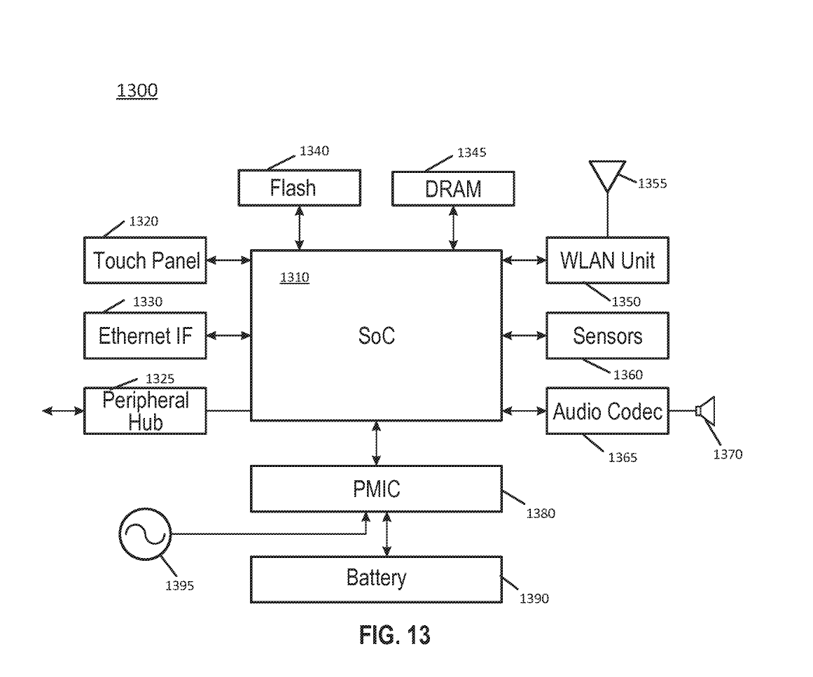

Referring now to FIG. 13, shown is a block diagram of another example system with which embodiments may be used. In the illustration of FIG. 13, system 1300 may be mobile low-power system such as a tablet computer, 2:1 tablet, phablet or other convertible or standalone tablet system. As illustrated, a SoC 1310 is present and may be configured to operate as an application processor for the device.

A variety of devices may couple to SoC 1310. In the illustration shown, a memory subsystem includes a flash memory 1340 and a DRAM 1345 coupled to SoC 1310. In addition, a touch panel 1320 is coupled to the SoC 1310 to provide display capability and user input via touch, including provision of a virtual keyboard on a display of touch panel 1320. To provide wired network connectivity, SoC 1310 couples to an Ethernet interface 1330. A peripheral hub 1325 is coupled to SoC 1310 to enable interfacing with various peripheral devices, such as may be coupled to system 1300 by any of various ports or other connectors.

In addition to internal power management circuitry and functionality within SoC 1310, a PMIC 1380 is coupled to SoC 1310 to provide platform-based power management, e.g., based on whether the system is powered by a battery 1390 or AC power via an AC adapter 1395. In addition to this power source-based power management, PMIC 1380 may further perform platform power management activities based on environmental and usage conditions. Still further, PMIC 1380 may communicate control and status information to SoC 1310 to cause various power management actions within SoC 1310.

Still referring to FIG. 13, to provide for wireless capabilities, a WLAN unit 1350 is coupled to SoC 1310 and in turn to an antenna 1355. In various implementations, WLAN unit 1350 may provide for communication according to one or more wireless protocols.

As further illustrated, a plurality of sensors 1360 may couple to SoC 1310. These sensors may include various accelerometer, environmental and other sensors, including user gesture sensors. Finally, an audio codec 1365 is coupled to SoC 1310 to provide an interface to an audio output device 1370. Of course understand that while shown with this particular implementation in FIG. 13, many variations and alternatives are possible.

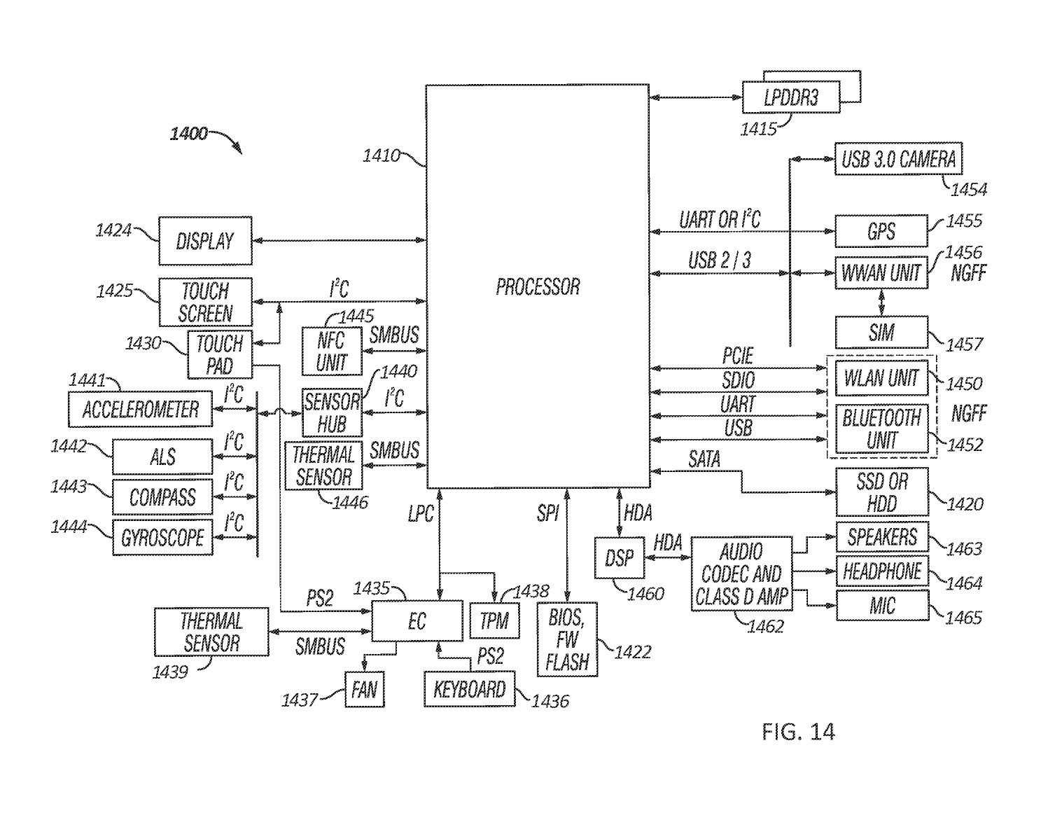

Referring now to FIG. 14, shown is a block diagram of a representative computer system such as notebook, Ultrabook™ or other small form factor system. A processor 1410, in one embodiment, includes a microprocessor, multi-core processor, multithreaded processor, an ultra low voltage processor, an embedded processor, or other known processing element. In the illustrated implementation, processor 1410 acts as a main processing unit and central hub for communication with many of the various components of the system 1400. As one example, processor 1410 is implemented as a SoC.

Processor 1410, in one embodiment, communicates with a system memory 1415. As an illustrative example, the system memory 1415 is implemented via multiple memory devices or modules to provide for a given amount of system memory.

To provide for persistent storage of information such as data, applications, one or more operating systems and so forth, a mass storage 1420 may also couple to processor 1410. In various embodiments, to enable a thinner and lighter system design as well as to improve system responsiveness, this mass storage may be implemented via a SSD or the mass storage may primarily be implemented using a hard disk drive (HDD) with a smaller amount of SSD storage to act as a SSD cache to enable non-volatile storage of context state and other such information during power down events so that a fast power up can occur on re-initiation of system activities. Also shown in FIG. 14, a flash device 1422 may be coupled to processor 1410, e.g., via a serial peripheral interface (SPI). This flash device may provide for non-volatile storage of system software, including a basic input/output software (BIOS) as well as other firmware of the system.

Various input/output (I/O) devices may be present within system 1400. Specifically shown in the embodiment of FIG. 14 is a display 1424 which may be a high definition LCD or LED panel that further provides for a touch screen 1425. In one embodiment, display 1424 may be coupled to processor 1410 via a display interconnect that can be implemented as a high performance graphics interconnect. Touch screen 1425 may be coupled to processor 1410 via another interconnect, which in an embodiment can be an I²C interconnect. As further shown in FIG. 14, in addition to touch screen 1425, user input by way of touch can also occur via a touch pad 1430 which may be configured within the chassis and may also be coupled to the same I²C interconnect as touch screen 1425.

For perceptual computing and other purposes, various sensors may be present within the system and may be coupled to processor 1410 in different manners. Certain inertial and environmental sensors may couple to processor 1410 through a sensor hub 1440, e.g., via an I²C interconnect. In the embodiment shown in FIG. 14, these sensors may include an accelerometer 1441, an ambient light sensor (ALS) 1442, a compass 1443 and a gyroscope 1444. Other environmental sensors may include one or more thermal sensors 1446 which in some embodiments couple to processor 1410 via a system management bus (SMBus) bus.

Also seen in FIG. 14, various peripheral devices may couple to processor 1410 via a low pin count (LPC) interconnect. In the embodiment shown, various components can be coupled through an embedded controller 1435. Such components can include a keyboard 1436 (e.g., coupled via a PS2 interface), a fan 1437, and a thermal sensor 1439. In some embodiments, touch pad 1430 may also couple to EC 1435 via a PS2 interface. In addition, a security processor such as a trusted platform module (TPM) 1438 may also couple to processor 1410 via this LPC interconnect.

System 1400 can communicate with external devices in a variety of manners, including wirelessly. In the embodiment shown in FIG. 14, various wireless modules, each of which can correspond to a radio configured for a particular wireless communication protocol, are present. One manner for wireless communication in a short range such as a near field may be via a NFC unit 1445 which may communicate, in one embodiment with processor 1410 via an SMBus. Note that via this NFC unit 1445, devices in close proximity to each other can communicate.

As further seen in FIG. 14, additional wireless units can include other short range wireless engines including a WLAN unit 1450 and a Bluetooth™ unit 1452. Using WLAN unit 1450, Wi-Fi™ communications can be realized, while via Bluetooth™ unit 1452, short range Bluetooth™ communications can occur. These units may communicate with processor 1410 via a given link.

In addition, wireless wide area communications, e.g., according to a cellular or other wireless wide area protocol, can occur via a WWAN unit 1456 which in turn may couple to a subscriber identity module (SIM) 1457. In addition, to enable receipt and use of location information, a GPS module 1455 may also be present. Note that in the embodiment shown in FIG. 14, WWAN unit 1456 and an integrated capture device such as a camera module 1454 may communicate via a given link.

To provide for audio inputs and outputs, an audio processor can be implemented via a digital signal processor (DSP) 1460, which may couple to processor 1410 via a high definition audio (HDA) link. Similarly, DSP 1460 may communicate with an integrated coder/decoder (CODEC) and amplifier 1462 that in turn may couple to output speakers 1463 which may be implemented within the chassis. Similarly, amplifier and CODEC 1462 can be coupled to receive audio inputs from a microphone 1465 which in an embodiment can be implemented via dual array microphones (such as a digital microphone array) to provide for high quality audio inputs to enable voice-activated control of various operations within the system. Note also that audio outputs can be provided from amplifier/CODEC 1462 to a headphone jack 1464. Although shown with these particular components in the embodiment of FIG. 14, understand the scope of the present invention is not limited in this regard.

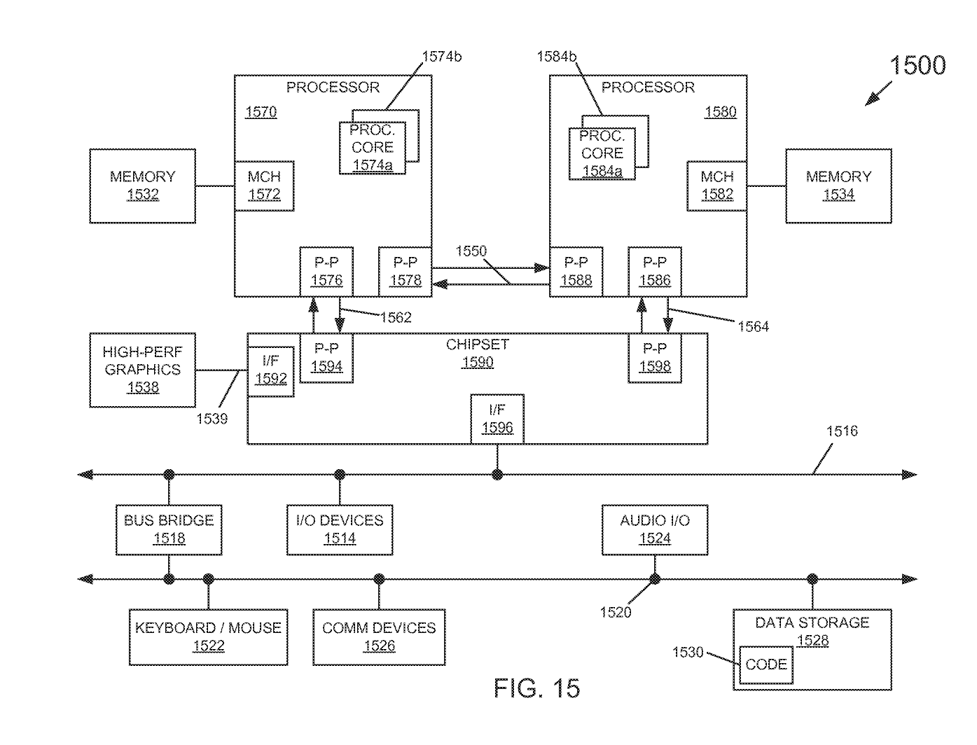

Embodiments may be implemented in many different system types. Referring now to FIG. 15, shown is a block diagram of a system in accordance with an embodiment of the present invention. As shown in FIG. 15, multiprocessor system 1500 is a point-to-point interconnect system, and includes a first processor 1570 and a second processor 1580 coupled via a point-to-point interconnect 1550. As shown in FIG. 15, each of processors 1570 and 1580 may be multicore processors, including first and second processor cores (i.e., processor cores 1574a and 1574b and processor cores 1584a and 1584b), although potentially many more cores may be present in the processors. Each of the processors can include a PCU or other power management logic to perform processor-based power management as described herein, including the internal power delivery for monitoring and reporting as described herein.

Still referring to FIG. 15, first processor 1570 further includes a memory controller hub (MCH) 1572 and point-to-point (P-P) interfaces 1576 and 1578. Similarly, second processor 1580 includes a MCH 1582 and P-P interfaces 1586 and 1588. As shown in FIG. 15, MCH's 1572 and 1582 couple the processors to respective memories, namely a memory 1532 and a memory 1534, which may be portions of system memory (e.g., DRAM) locally attached to the respective processors. First processor 1570 and second processor 1580 may be coupled to a chipset 1590 via P-P interconnects 1562 and 1564, respectively. As shown in FIG. 15, chipset 1590 includes P-P interfaces 1594 and 1598.

Furthermore, chipset 1590 includes an interface 1592 to couple chipset 1590 with a high performance graphics engine 1538, by a P-P interconnect 1539. In turn, chipset 1590 may be coupled to a first bus 1516 via an interface 1596. As shown in FIG. 15, various input/output (I/O) devices 1514 may be coupled to first bus 1516, along with a bus bridge 1518 which couples first bus 1516 to a second bus 1520. Various devices may be coupled to second bus 1520 including, for example, a keyboard/mouse 1522, communication devices 1526 and a data storage unit 1528 such as a disk drive or other mass storage device which may include code 1530, in one embodiment. Further, an audio I/O 1524 may be coupled to second bus 1520. Embodiments can be incorporated into other types of systems including mobile devices such as a smart cellular telephone, tablet computer, netbook, Ultrabook™, or so forth.

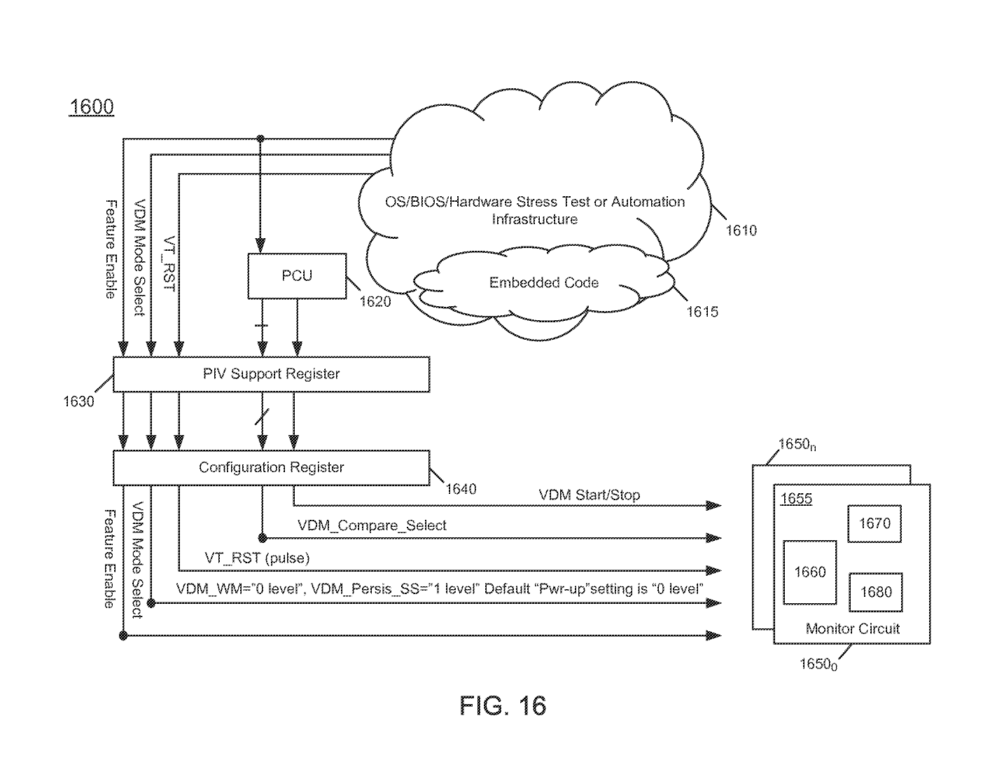

Referring now to FIG. 16, shown is a block diagram of a processor in accordance with an embodiment of the present invention. As shown in FIG. 16, processor 1600 may take the form of any type of microprocessor, such as a single core processor, multicore processor or other SoC. For purposes of illustrating the high-level architecture of a monitoring architecture as described herein, details of the cores and other IP logics of the processor (and uncore circuitry) are not shown in FIG. 16.

Instead, FIG. 16 shows details of the monitoring architecture itself. As seen, a PCU 1620 is coupled to receive information from a given infrastructure 1610, which in an embodiment may be one or more of an OS/BIOS/hardware-based stress test or automation infrastructure, or from the platform operating system itself. In some embodiments, infrastructure 1610 may further include an embedded code portion 1615 that may provide for virus characterization. In the embodiment shown, infrastructure 1610 or 1620 provides a control signal, which is implemented in an embodiment as a feature enable signal, to indicate when monitoring is to be activated and/or deactivated. As further shown, PCU 1620 couples to a machine specific register (MSR) 1630, also referred to herein as a PIV support register, which in an embodiment is a persistent register that is BIOS/OS/power management visible, to store support information for monitoring as described herein. As seen, certain control signals may be provided to register 1630 from both of infrastructure 1610 and PCU 1620.

In turn, register 1630 couples to an execution configuration storage engine 1640, which in an embodiment may be implemented as a persistent execution control and configuration register, such that certain information from register 1630 may be written into register 1640. From there, such control/configuration information may be provided to corresponding domains of the processor. More specifically, processor 1600 includes domains 1650ₐ-1650ₙ, each of which may be implemented as an independent voltage/frequency domain, and which may include one or more cores or other IP logic. In addition, each domain 1650 is shown to include at least one monitor circuit 1655, which may include a state machine 1660 coupled to a supply voltage via a power gate circuit. Monitor circuit 1655 further includes a repeater circuit 1670, and a ring oscillator 1680.

In the embodiment of FIG. 16, PCU 1620 may control when voltage monitoring occurs through special handshakes to the monitoring substructures, including via registers 1630 and 1640, to realize communication with voltage monitoring circuits 1655 within domains 1650. Such handshakes ensure that measurements occur during active modes of operation only. The resiliency of the microarchitecture enables monitoring to be suspended and resumed through controls integrated into PCU 1620 and supporting communications to the monitoring substructures. That is, as PCU 1620 has visibility to the actual P-state selection and ratio selection at any given point in time (e.g., domain-by-domain voltage/frequency pairs), the dynamic nature of this logic participates in real time configuring on-die monitors, which enables the capture of voltage tolerancing or voltage averaging data of the PDN over time.

In an embodiment, each domain 1650 includes a unique, persistent register array allocated for V/F sets represented by a P-state table (e.g., 3 V/F base entries and offsets associated with a given IP block). This enables measurement capability through the tracking and dynamic modification of a comparison register selection via an indexing scheme used during active monitoring. Although the scope of the present invention is not limited in this regard, in an embodiment a voltage monitoring circuit can be implemented as a voltage droop monitor (VDM). As an example, monitoring circuit 1655 may be configured to monitor voltage by performing a comparison between a frequency being output by ring oscillator 1680 (which in an embodiment may be determined by counting a number of cycles output by this ring oscillator) with a comparison value, corresponding to a calibrated, expected number of cycles. Based on this comparison, it can be determined whether the operating voltage is higher than or lower than the expected or typical operating voltage associated with the operating frequency of the domain. An appropriate recording of the determined operating voltage can occur. As will be described further herein, in certain embodiments, rather than a cycle-by-cycle or sample-based recording of operating voltage, a watermark value (a running minimum or maximum voltage seen over time) or an average value may be maintained to reduce storage requirements. Of course, understand that other monitors such as the SVM, ODDD, or mVDM can readily be used as well.

Note that each monitor circuit 1650 may include registers or other persistent storages (e.g., connected to an always on power rail, such as an SRAM rail), which may be OS/BIOS visible. Such registers include threshold registers that may be indexed to support voltage monitoring during any of voltage and ratio condition or multiple P-state conditions for a given IP block, and may be OS/BIOS visible. Understand while shown at this high level in the embodiment of FIG. 16, many variations and alternatives are possible. A threshold excursion counter may be configured to enable the counting of measurements that dip below a user-configured threshold. The visibility of this data allows the user to make decisions surrounding the health of the PDN over time. Such information may be used for Q & R or platform autonomics disciplines, as well as design/validation teams. In embodiments, the threshold holding register (indexed) and mode configuration registers are persistent and included to comprehend and preserve state throughout a given system monitoring exercise.

In embodiments, monitor circuit 1650 may include an internal clock to support power delivery monitoring at the SoC level (e.g., monitors of power rails outside specific IP blocks) or in IP blocks where an available clock is below a minimum frequency (e.g., 1 GHz). This self-clocking capability provides a mechanism to ensure flexibility to enable the architecture's use on any product. This is a special mode of operation that enables the use of an internal ring oscillator as the clock for all internal control features of the voltage monitors and may eliminate the need for a routed test clock in non-IP block monitoring locations.

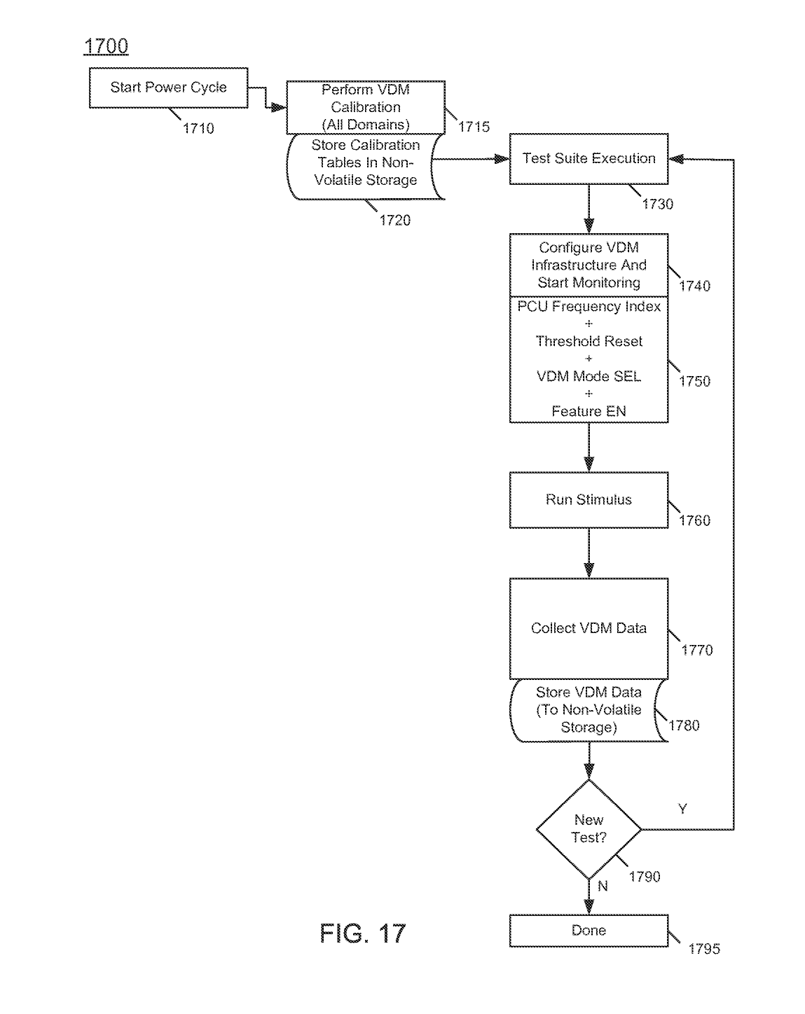

Referring now to FIG. 17, shown is a flow diagram of a voltage monitoring method in accordance with an embodiment of the present invention. As shown in FIG. 17, method 1700 can be performed by various combinations of hardware, software, and/or firmware, including control logic present within a PCU, along with logic such as a state machine of a monitor circuit of a given domain of a processor. As seen, method 1700 begins by receiving a start command at block 1710. Thereafter, a calibration process may be performed for a given voltage monitor (block 1715). That is, for this calibration, which may be a one time process, the ring oscillator of each voltage monitor circuit can be calibrated for the expected voltage measurement range for any given frequency at which the domain may operate to account for cross-die variation. The results of such calibration may be stored in calibration tables stored in non-volatile storage (block 1720). These resulting calibration tables may be accessed during normal operation to obtain count values associated with particular ring oscillators of the voltage monitor circuits to be used for purposes of operating voltage determinations.

In an embodiment, this voltage monitoring calibration can be performed when there is a stable voltage value and a PLL or other clock generator for the domain is locked. In one embodiment, the calibration may be performed by calculating ring oscillator count averages for a single potential domain clock frequency from which count averages can be inferred with unflawed accuracy for all potential frequency settings. From this information, a calibration table can be generated. In one such embodiment, this calibration table may be generated per voltage monitor/IP block with an entry for each clock frequency and can be stored in a given non-volatile storage (block 1720). Thereafter, at block 1730, test execution may begin. In one embodiment, this test may be an OS-implemented test executive script. To begin such a test executive, control passes to block 1730 where configuration information may be written to a corresponding voltage monitor circuit, and monitoring may begin. In one embodiment, a PIV support register may be written with a control sequence. In an embodiment, such sequence may include various control information for the voltage monitor circuit, including a threshold reset, a mode select, and a feature enable. Still further, the voltage monitor circuit may be set with index bits for a corresponding frequency setting for the domain. Voltage monitoring sampling may begin when the processor is in active state, via a start/stop bit. In one embodiment, direct wiring from a PCU or PIV support register to a voltage monitor may be implemented.

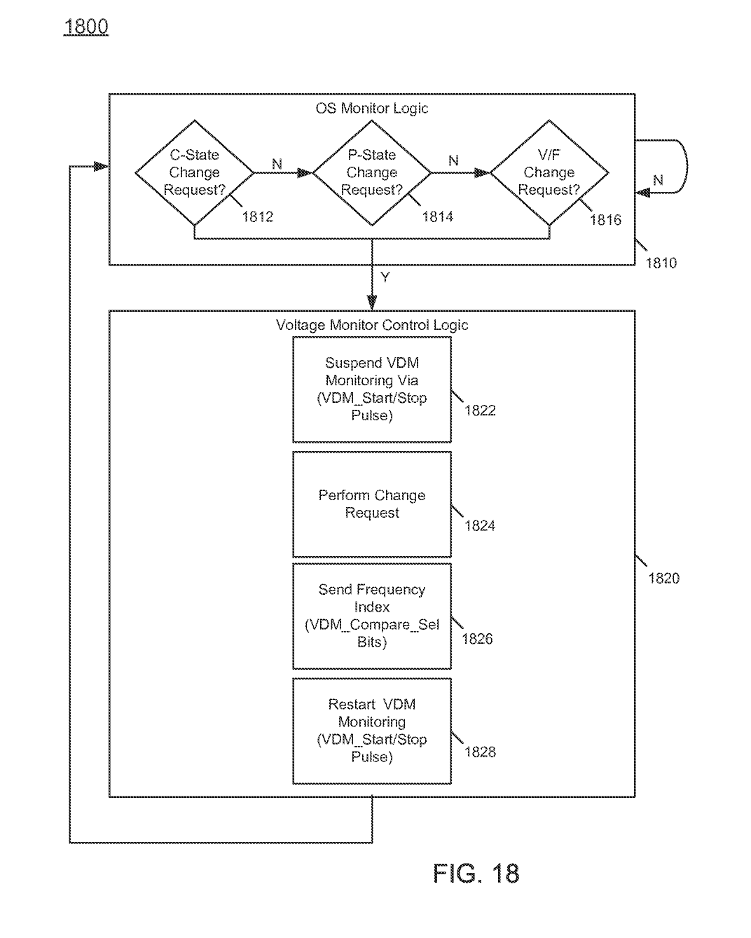

At this point, a stress application may begin execution. More specifically, at block 1760 a stimulus of the stress execution test may be run. Details are described further with regard to FIG. 18. After the stress application is executed, voltage monitoring sampling may stop based on control of a feature enable bit. Control passes to block 1770 where voltage monitoring data may be collected. This collected voltage monitoring information may be stored in a non-volatile storage (block 1780). Note that in different embodiments, at a conclusion of stress application, industry application or benchmark testing, the OS test executive writes a zero to the feature enable signal, which stops the voltage sampling, and allows measurement data collection (at block 1770). In one embodiment, the voltage monitoring data may be stored in an electrical validation database. Thereafter it is determined whether a new test is to be performed (diamond 1790). If so, control passes back to block 1730. Otherwise voltage monitoring concludes (block 1795).

Note that in method 1700, there is no impact from a Heisenberg effect perspective in that zero CPU cycles are used by the microarchitecture to achieve its objective. Understand while shown at this high level in the embodiment of FIG. 17, many variations and alternatives are possible. For example, while described as voltage monitoring, embodiments are not limited in this regard and are applicable to other power-related monitoring, such as current, power, capacitance, and so forth.

Referring now to FIG. 18, shown is a flow diagram of details of a monitoring voltage monitoring method in accordance with an embodiment of the present invention. As seen in FIG. 18, method 1800 may be performed by interaction between an OS and a PCU, such as during execution of an OS test executive. As seen, a power controller includes an OS monitor logic 1810, which in an embodiment may be implemented by hardware, software, and/or firmware such as a state machine, to determine whether an OS request is received. As seen, such request may be a request for a C-state change (diamond 1812), a P-state change (diamond 1814), or a voltage/frequency change (diamond 1816). If any such request is received, a voltage monitor control logic 1820 is activated. This logic may be implemented by hardware, software, and/or firmware, such as another state machine of the PCU.

As seen, this logic may include various constituent logics, to perform operations including a suspension operation 1822 which may suspend voltage monitoring, e.g., via a start/stop indicator, a change operation 1824 which may perform the requested OS activity state/performance state/voltage/frequency change, an index operation 1826 which sends an index value, and a voltage monitoring operation 1828, which may restart voltage monitoring responsive to a start/stop indicator, when the updated voltage/frequency is stable/locked.

Thus during the stress application testing, if a given power-related change is indicated, the PCU may suspend voltage monitoring sampling (note that the threshold data registers and configuration registers remain persistent). Thereafter, the PCU makes the indicated change, and updates the compare register index, which in turn indicates the appropriate data register to be selected for comparison. Then when the voltage is stable and the PLL or other clock generator is locked, voltage monitoring sampling begins again (using the appropriate index register for comparison).

Similarly, on a transition from an active to an inactive state, voltage monitoring sampling is suspended (with its data persisting). Then when an active state transition occurs, when the voltage is stable and the PLL or other clock generator is locked, voltage monitoring sampling begins again.

In various embodiments, one or more microbreakpoint engines (MBP) 1640 also identified within as the execution configuration register of a domain may be used to supply synchronization control. For example, the MBP engine enables clock cycle accurate correlation of system events with measurements taken by the monitoring circuits. A MBP engine may also be used to synchronize the start/stop of on-die OS level stress test stimulus with power grid sampling. In an embodiment, each power domain 1650 may include one or more of its own microbreakpoint engines beyond 1640 which are also independently configurable. Each MBP engine may provide a set of event triggering and corresponding action features. Several specific features are built-in to each MBP engine, including the ability to start/stop power monitoring sampling and on-die test stimulus as well as to stop a debug synchronization counter upon monitoring events. In addition, integrated MBP counters are utilized in voltage measurement algorithms to coordinate and capture time specific properties during test execution cycles. Such internal counter(s) may also be used in conjunction with other external clock counter mechanisms for temporal correlation of test failures or system events relative to the start of test content execution. Using a MBP engine, multiple trigger/action pairs can be supported simultaneously. Using such MBP engines, both temporal and spatial identification of power-related issues such as during debugging or fault detection can be realized. Stated another way, using the synchronization features available, it can be determined with high cycle accuracy exactly where in execution of a program that an undesired voltage excursion or other power-related issue occurred, easing debugging.

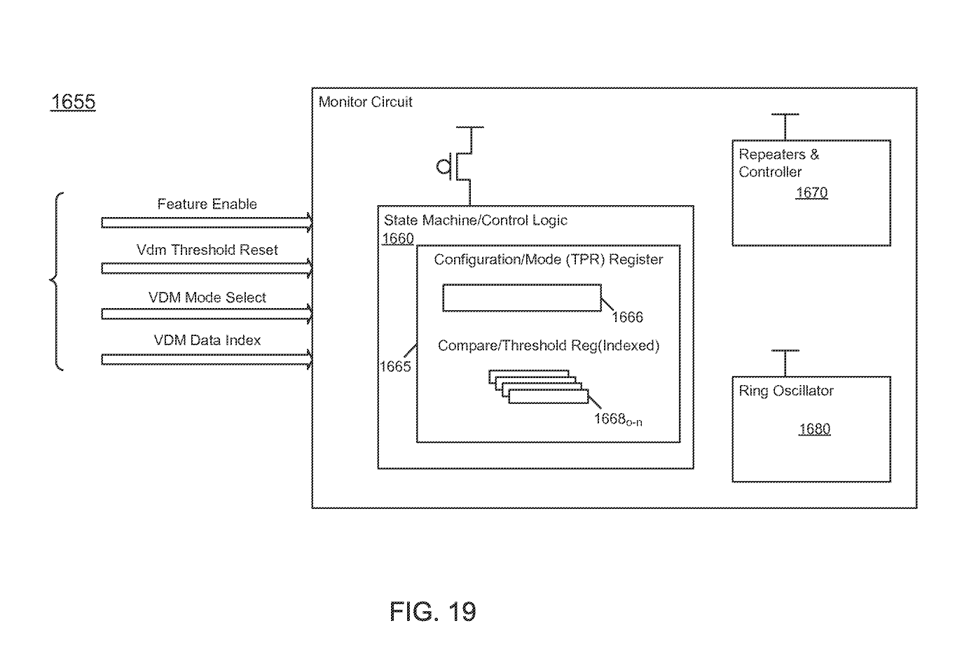

Referring now to FIG. 19, shown is a block diagram illustrating further details of a voltage monitor circuit in accordance with an embodiment. As shown in FIG. 19 a voltage monitoring circuit 1655 includes a state machine 1660 that in turn includes a set of persistent registers 1665, including a configuration/mode register 1666 and index comparison/threshold registers 1668₀-1668ₙ. Using these registers, various voltage monitoring modes of operation can be realized, including a running average voltage mode and a minimum voltage mode. As further seen, monitor circuit 1655 includes repeaters and a controller 1670 to provide for adequate voltage operation and support of oscillator 1680. As further illustrated, control signals are received through control operation of monitor circuit 1650. As described above, combinations of these signals can be received from a variety of sources, including directly from the PCU and/or via visible registers 1630 and 1640. Still further, in some cases control signals, including start/stop signals (not shown for ease of illustration) may be received from a given MBP engine, starting and stopping of the voltage monitoring as described herein.

In various embodiments, multiple monitoring modes of operation can be realized. In an embodiment, the multiple modes may include a watermark mode, an averaging mode, a “self-clocking” mode, and a self-calibration mode. In an embodiment, in an averaging mode, a running average snapshot value can be determined, using an automated averaging logic of a monitor circuit 1655, to enable dynamic workload fingerprinting and load balancing. In an embodiment, the averaging logic or circuit creates a new value for the average comprehending all previously sampled data. This average value may be calculated upon receipt of each new sample, eliminating the storing of past sampled data values. The prior calculated average is multiplied by the previous number of data samples and the product is added to a new sample. The resultant sum is divided by the sequence number of the new sample and the quotient, which represents the new average value, is placed into a data storage. In this way, an averaging circuit consumes minimal data storage capability for continually calculating a numerical average of a given number of samples, where the number can be defined based on validation and platform autonomic application control.

Table 1 below identifies several of the monitoring modes and provides information regarding control and operation of the modes.

TABLE 1

| Monitor Modes | Detail |
|---|---|
| “Preset Watermark (WM)” | Default power on mode, WM |
| Monitor starts automatically | configuration preset. WM measurements |
| after initialization (C0) based | begin immediately upon reaching |
| on “VDM MODE SELECT” | active state (C0). |
| “Running Average Snapshot” | Mode for support of workload |
| Monitor starts automatically | fingerprinting (Validation Stress |
| after init (C0) based on | Characterization & Platform Autonomics). |
| “VDM MODE SELECT” | Calculates running average by use of |
| | an averaging circuit of the monitor. |

Referring now to Table 2, shown are example signals provided to a monitoring circuit in accordance with an embodiment, and associated detail of the operation controlled by such signals.

TABLE 2

| Input Bits | Bits | Detail |
|---|---|---|
| Feature Enable | 1 | 1 value enables use of Auto-Watermark & |
| | | Running Average Modes. If 0, then legacy |
| | | operation. |
| Vdm MODE | 1 | Monitor automatically power up in WM low or |
| SELECT | | in Persistent_Snapshot mode, and automatically |
| | | begins taking measurements once initialization is |
| | | complete (e.g., VID/PLL lock occurs). |
| Vdm Threshold | 1 | BIOS asynchronously sets to 1's the Vdm |
| Reset | | “threshold holding register” (Compare Value)” |
| | | during BOOT or via OS stress test. |
| Vdm Data | 3 | During normal mode operation, PCU provides |
| Index | | three P-state V/F options. The VDM Data Index |
| | | points to the correct data register, with index |
| | | correlating to a specific V/F pair. |
| VDM Internal | 1 | Transitions from IP domain clocking to internal |
| Clk Mode | | clocking. |
| Self Calibrate | 1 | Enables Automatic “PCU” based VDM |
| | | calibration. |

In an embodiment, voltage monitoring calibration can be performed once per product package due to process variation die-to-die, which may be performed at one or more of each frequency specified by a product's P-state voltage/frequency pairs. In an embodiment, this voltage monitoring calibration can be accomplished during system BIOS setup.

Table 3 provides information regarding example contents of persistent voltage monitor registers in accordance with an embodiment.

TABLE 3

| Persistent Reg's | Detail |
|---|---|
| TPR Register | TAP primary register (VDM configuration bits) |
| Threshold | Monitor automatically power up in WM low or in |
| Holding Register | Persistent_Snapshot mode automatically begins taking |
| | measurements once initialization is complete (e.g., |
| | VID/PLL lock occurs). |

Table 4 provides information regarding values stored in various fields of PCU and MSR storages.

TABLE 4

| Control Bit | Bits | Details |
|---|---|---|
| VDM OS | 1 | Enable the Auto WM and VDM Snapshot |
| Features Enable | | averaging features. If “0”, a legacy usage |
| | | application set can be used. |
| Vdm MODE | 1 | Two modes of operation, Auto WM - Capture |
| SELECT | | the lowest or highest voltage seen by each |
| | | monitor over the life of the OS stress test |
| | | executed. VDM Snapshot averaging - |
| | | Calculates a running average voltage over time |
| | | (over the life of the OS stress test executed). |
| Voltage | 1 | This feature automatically resets the monitor |
| Threshold RST | | voltage threshold to appropriate value for |
| | | capturing lowest voltage over the life of the |
| | | stress test executed. |
| VDM_Start/Stop | 1 | This PCU-controlled bit, which causes a pulse |
| | | (e.g., via a MBP engine) seen by the monitor. |
| | | It controls when the monitors start/stop |
| | | monitoring. There are two scenarios: 1) when |
| | | a VF P-state table change is required, and 2) |
| | | when a C0→C6 and “return to C0” state |
| | | transition happens. |
| Current/Next | 2 | The PCU provides the current V/F table entry |
| P-State Index | | on two bits. These two bits are persistent and |
| | | are always valid once the PCU is up and |
| | | running. This information indicates which |
| | | calibration table to use during measurements. |
| VDM Internal | 1 | Transitions from IP domain clocking to |
| Clk Mode | | internal clocking. |
| Self Calibrate | 1 | Enables Automatic “PCU” based VDM |
| | | calibration. |

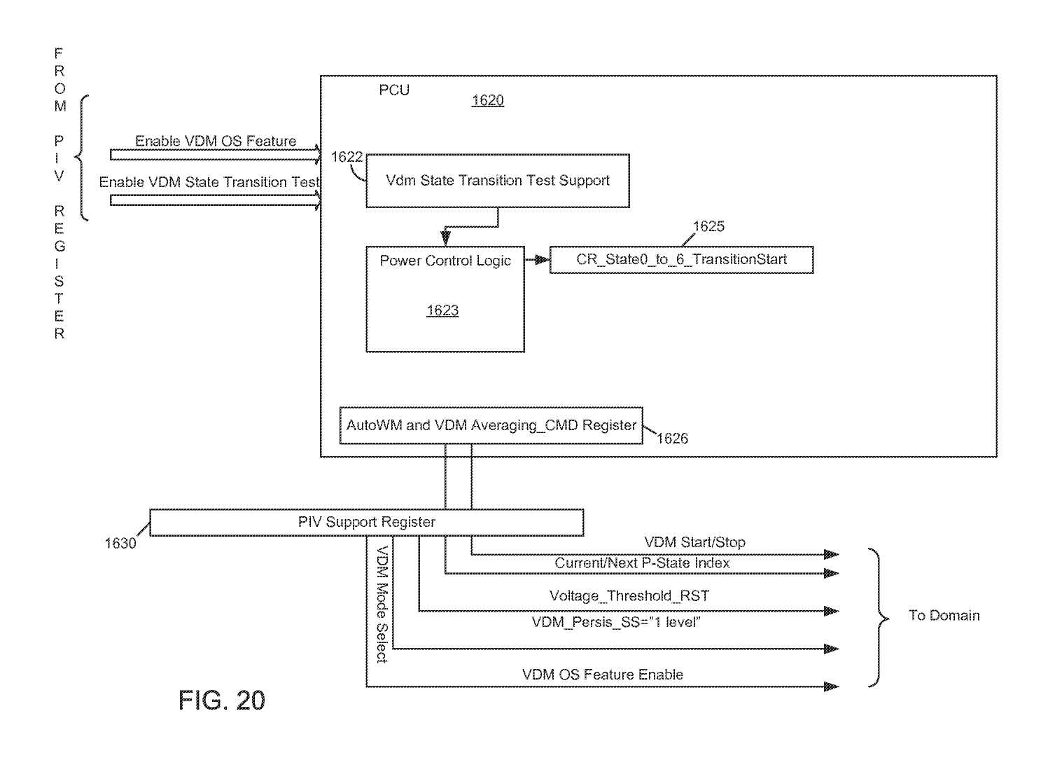

Referring now to FIG. 20, shown is a block diagram that sets forth certain details regarding a PCU in accordance with an embodiment. As shown, PCU 1620 includes a power control logic 1623, which may be combinations of circuitry having hardware, software, and/or firmware. For example, in one embodiment logic 1623 may be a microcontroller or other control logic to execute power-related code, such as power code stored in a non-volatile storage of the PCU. A VDM state transition test support storage 1622 may be used to trigger power control logic 1623 upon a C-state change, that in turn writes to a control register 1625, which may be used to initiate start/stop pulses to given monitoring circuits. As further shown, PCU 1620 includes a command register 1626 that may control the mode of voltage monitoring, such as selection between a watermark and an average mode as well as which threshold register index to write measurement data to during the current active monitoring state. As previously illustrated, PCU 1620 couples to PIV support register 1630 which in turn may communicate to one or more domains, either to a MBP engine within the domain, or to one or more monitoring circuits within the domain, directly. Still further, some information from PIV support register 1630 may be provided back to PCU 1620, in instances where such information is written by a given infrastructure such as an OS/BIOS.

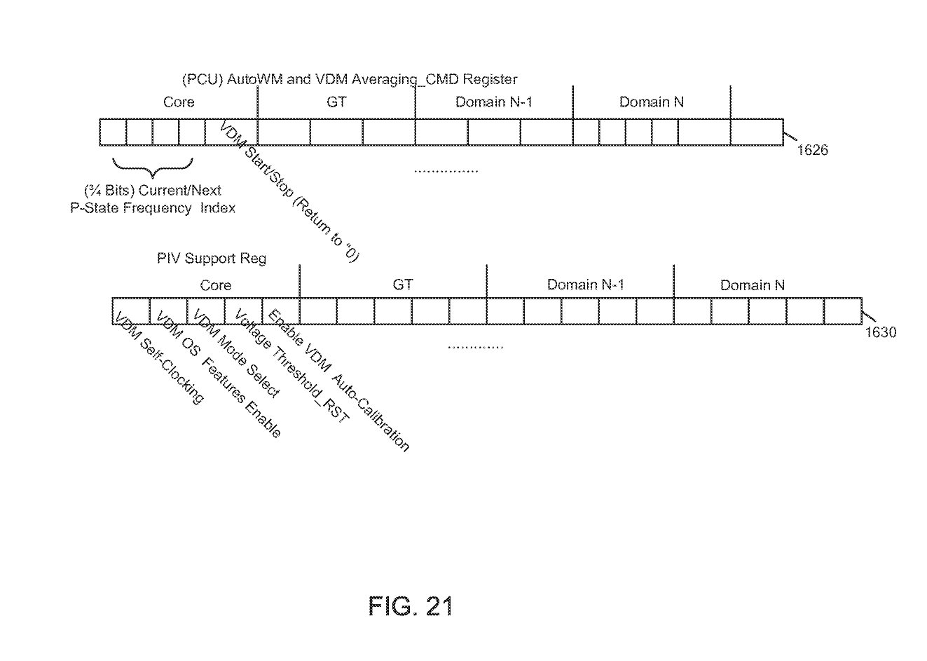

Referring now to FIG. 21, shown is a block diagram of details of command register 1626 and PIV support register 1630. As seen, each register may include a plurality of fields each associated with a given core, graphics domain (GT) or other processor domain. First with reference to command register 1626, each field may include multiple bits to identify a current or next P-state frequency. As such, these bits may provide an index to be used by a given monitor circuit to index a comparison register. Furthermore, each field may include a start/stop bit to indicate when voltage monitoring as described herein is to be enabled/disabled. In turn, PIV support register 1630 provides, for each field a feature enable bit, which may be set by the OS, a VDM mode select bit, a voltage threshold_reset bit, and an auto-calibration bit. Details of these bits are described above with regard to Table 4, above. Note that the calibration bit allows for the option of having code within the PCU to perform the VDM calibration.

In various embodiments, monitoring circuit instances can be placed throughout a processor or other SoC. In an embodiment, the monitor circuits can reside at SoC level or within a specific IP block of the SoC.

Embodiments may use the techniques described herein for PDN optimization such as voltage guardband determination and optimization, and dynamic workload characterization and balancing, platform autonomics related workload balancing, volume validation characterization of power tolerances, among other usages.

One or more aspects of at least one embodiment may be implemented by representative code stored on a machine-readable medium which represents and/or defines logic within an integrated circuit such as a processor. For example, the machine-readable medium may include instructions which represent various logic within the processor. When read by a machine, the instructions may cause the machine to fabricate the logic to perform the techniques described herein. Such representations, known as “IP cores,” are reusable units of logic for an integrated circuit that may be stored on a tangible, machine-readable medium as a hardware model that describes the structure of the integrated circuit. The hardware model may be supplied to various customers or manufacturing facilities, which load the hardware model on fabrication machines that manufacture the integrated circuit. The integrated circuit may be fabricated such that the circuit performs operations described in association with any of the embodiments described herein.

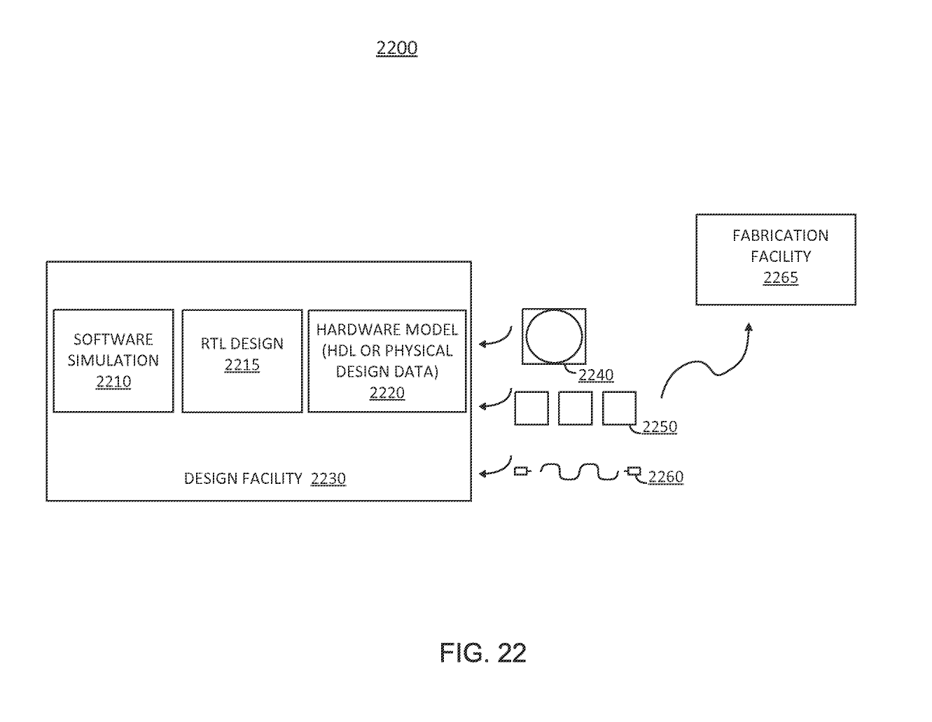

FIG. 22 is a block diagram illustrating an IP core development system 2200 that may be used to manufacture an integrated circuit to perform operations according to an embodiment. The IP core development system 2200 may be used to generate modular, reusable designs that can be incorporated into a larger design or used to construct an entire integrated circuit (e.g., an SoC integrated circuit). A design facility 2230 can generate a software simulation 2210 of an IP core design in a high level programming language (e.g., C/C++). The software simulation 2210 can be used to design, test, and verify the behavior of the IP core. A register transfer level (RTL) design can then be created or synthesized from the simulation model. The RTL design 2215 is an abstraction of the behavior of the integrated circuit that models the flow of digital signals between hardware registers, including the associated logic performed using the modeled digital signals. In addition to an RTL design 2215, lower-level designs at the logic level or transistor level may also be created, designed, or synthesized. Thus, the particular details of the initial design and simulation may vary.

The RTL design 2215 or equivalent may be further synthesized by the design facility into a hardware model 2220, which may be in a hardware description language (HDL), or some other representation of physical design data. The HDL may be further simulated or tested to verify the IP core design. The IP core design can be stored for delivery to a third party fabrication facility 2265 using non-volatile memory 2240 (e.g., hard disk, flash memory, or any non-volatile storage medium). Alternately, the IP core design may be transmitted (e.g., via the Internet) over a wired connection 2250 or wireless connection 2260. The fabrication facility 2265 may then fabricate an integrated circuit that is based at least in part on the IP core design. The fabricated integrated circuit can be configured to perform operations in accordance with at least one embodiment described herein.

The following examples pertain to further embodiments.

In one example, a processor comprises: at least one domain to operate at an independent voltage and frequency, the at least one domain including a monitor circuit; and a power controller to control power consumption of the at least one domain and to control the monitor circuit to monitor an operating voltage of the at least one domain during active operation of the at least one domain and to prevent the monitor circuit from the monitoring of the operating voltage when the at least one domain is inactive.

In an example, the power controller is to cause the monitor circuit to monitor the operating voltage according to a first mode in which a minimum voltage is to be reported.

In an example, the power controller is to cause the monitor circuit to monitor the operating voltage according to a second mode in which an average voltage is to be reported.

In an example, the monitor circuit comprises: a configuration storage to store a first indicator to indicate whether the monitor circuit is to monitor the operating voltage according to the first mode or the second mode; and a plurality of threshold storages each to store a threshold voltage associated with a frequency of the at least one domain.

In an example, the power controller is to send an index signal to the monitor circuit to cause the threshold voltage stored in a corresponding one of the plurality of threshold storages to be used by a comparison logic of the monitor circuit.

In an example, the comparison logic is, during a plurality of cycles, to compare the threshold voltage to the operating voltage and to update the average voltage based at least in part on the comparison.

In an example, the processor further comprises a first storage coupled to the power controller to store an enable indicator to indicate whether the monitor circuit is to be enabled, the first storage visible to one or more of an OS and a BIOS.

In an example, the power controller is to update the enable indicator to indicate that the monitor circuit is to be enabled, responsive to initiation of a stress test application.

In an example, the power controller is to control the monitor circuit to halt the operating voltage monitoring when the at least one domain is to enter into a low power state.

In an example, the power controller is to control the monitor circuit to re-enter the operating voltage monitoring when the at least one domain is to exit into the low power state.

Note that the above processor can be implemented using various means.

In an example, the processor comprises a SoC incorporated in a user equipment touch-enabled device.

In another example, a system comprises a display and a memory, and includes the processor of one or more of the above examples.

In another example, a method comprises: configuring a voltage monitor circuit of a first domain of a processor to monitor an operating voltage of the first domain according to one of a plurality of monitor modes; causing the voltage monitor circuit to compare the operating voltage to a first reference value based on a first index code, the first reference value associated with a first operating frequency at which the first domain is operating; and enabling the voltage monitor circuit to monitor the operating voltage when the first domain is in an active mode and suspend the operating voltage monitoring when the first domain is in an inactive mode.

In an example, the method further comprises re-enabling the voltage monitor circuit to monitor the operating voltage after suspending the operating voltage monitoring when the first domain returns to the active mode.

In an example, the method further comprises configuring the voltage monitor circuit of the first domain responsive to execution of a stress test application.

In an example, the method further comprises recording a minimum voltage of the operating voltage during the stress test application, in a first monitor mode.

In an example, the method further comprises recording an average voltage of the operating voltage during the stress test application and not storing a plurality of samples of the operating voltage, in a second monitor mode.

In an example, the method further comprises debugging the processor, including using information from the voltage monitor circuit to determine spatial and temporal location of an operating voltage excursion during execution of an application, and without use of telemetry circuitry.

In another example, a computer readable medium including instructions is to perform the method of any of the above examples.

In another example, a computer readable medium including data is to be used by at least one machine to fabricate at least one integrated circuit to perform the method of any one of the above examples.

In another example, an apparatus comprises means for performing the method of any one of the above examples.

In a still further example, a system comprises: a processor including a plurality of domains each having at least one execution logic and at least one monitor circuit to monitor power delivery to the domain, and a power control unit to control the at least one monitor circuit based on a performance state and an activity state of the domain; and a communication interface to communicate power delivery information to a destination.

In an example, the at least one monitor circuit comprises a configuration storage to store a first indicator to indicate whether the at least one monitor circuit is to monitor an operating voltage according to a first mode or a second mode, and a plurality of threshold storages each to store a threshold voltage associated with a frequency of the domain, the first mode comprising a minimum voltage mode, the second mode comprising an average voltage mode.

In an example, a first domain of the plurality of domains comprises a first microbreakpoint engine to synchronize a temporal and spatial location of a voltage event with a synchronization counter.

In an example, the power control unit is to send a stop signal to the first microbreakpoint engine responsive to a performance state change for the first domain, and the first microbreakpoint engine is to cause the at least one monitor circuit to suspend the power delivery monitoring responsive to the stop signal.

In an example, the processor further comprises a first storage coupled to the power control unit, the first storage including a plurality of fields each associated with one of the plurality of domains to store an enable indicator to indicate whether the power delivery monitoring is to be enabled, the first storage visible to one or more of an OS and a BIOS.

In an example, the at least one monitor circuit is to monitor an operating voltage provided to the domain.

Embodiments may be used in many different types of systems. For example, in one embodiment a communication device can be arranged to perform the various methods and techniques described herein. Of course, the scope of the present invention is not limited to a communication device, and instead other embodiments can be directed to other types of apparatus for processing instructions, or one or more machine readable media including instructions that in response to being executed on a computing device, cause the device to carry out one or more of the methods and techniques described herein.

Embodiments may be implemented in code and may be stored on a non-transitory storage medium having stored thereon instructions which can be used to program a system to perform the instructions. Embodiments also may be implemented in data and may be stored on a non-transitory storage medium, which if used by at least one machine, causes the at least one machine to fabricate at least one integrated circuit to perform one or more operations. The storage medium may include, but is not limited to, any type of disk including floppy disks, optical disks, solid state drives (SSDs), compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), magnetic or optical cards, or any other type of media suitable for storing electronic instructions.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A processor comprising:
at least one domain to operate at an independent voltage and frequency, the at least one domain including a monitor circuit; and
a power controller to control power consumption of the at least one domain and to control the monitor circuit to monitor an operating voltage of the at least one domain during active operation of the at least one domain and to prevent the monitor circuit from the monitoring of the operating voltage when the at least one domain is inactive.

2. The processor of claim 1, wherein the power controller is to cause the monitor circuit to monitor the operating voltage according to a first mode in which a minimum voltage is to be reported.

3. The processor of claim 2, wherein the power controller is to cause the monitor circuit to monitor the operating voltage according to a second mode in which an average voltage is to be reported.

4. The processor of claim 3, wherein the monitor circuit comprises:
a configuration storage to store a first indicator to indicate whether the monitor circuit is to monitor the operating voltage according to the first mode or the second mode; and
a plurality of threshold storages each to store a threshold voltage associated with a frequency of the at least one domain.

5. The processor of claim 4, wherein the power controller is to send an index signal to the monitor circuit to cause the threshold voltage stored in a corresponding one of the plurality of threshold storages to be used by a comparison logic of the monitor circuit.

6. The processor of claim 5, wherein the comparison logic is, during a plurality of cycles, to compare the threshold voltage to the operating voltage and to update the average voltage based at least in part on the comparison.

7. The processor of claim 1, further comprising a first storage coupled to the power controller to store an enable indicator to indicate whether the monitor circuit is to be enabled, the first storage visible to one or more of an operating system (OS) and a basic input output system (BIOS).

8. The processor of claim 7, wherein the power controller is to update the enable indicator to indicate that the monitor circuit is to be enabled, responsive to initiation of a stress test application.

9. The processor of claim 1, wherein the power controller is to control the monitor circuit to halt the operating voltage monitoring when the at least one domain is to enter into a low power state.

10. The processor of claim 9, wherein the power controller is to control the monitor circuit to re-enter the operating voltage monitoring when the at least one domain is to exit into the low power state.

11. A machine-readable medium having stored thereon data, which if used by at least one machine, causes the at least one machine to fabricate at least one integrated circuit to perform a method comprising:
configuring a voltage monitor circuit of a first domain of a processor to monitor an operating voltage of the first domain according to one of a plurality of monitor modes;
causing the voltage monitor circuit to compare the operating voltage to a first reference value based on a first index code, the first reference value associated with a first operating frequency at which the first domain is operating; and
enabling the voltage monitor circuit to monitor the operating voltage when the first domain is in an active mode and suspend the operating voltage monitoring when the first domain is in an inactive mode.

12. The machine-readable medium of claim 11, wherein the method further comprises re-enabling the voltage monitor circuit to monitor the operating voltage after suspending the operating voltage monitoring when the first domain returns to the active mode.

13. The machine-readable medium of claim 11, wherein the method further comprises configuring the voltage monitor circuit of the first domain responsive to execution of a stress test application.

14. The machine-readable medium of claim 13, wherein the method further comprises recording a minimum voltage of the operating voltage during the stress test application, in a first monitor mode.

15. The machine-readable medium of claim 14, wherein the method further comprises recording an average voltage of the operating voltage during the stress test application and not storing a plurality of samples of the operating voltage, in a second monitor mode.

16. The machine-readable medium of claim 11, wherein the method further comprises debugging the processor, including using information from the voltage monitor circuit to determine spatial and temporal location of an operating voltage excursion during execution of an application, and without use of telemetry circuitry.

17. A system comprising:
a processor including a plurality of domains each having at least one execution logic and at least one monitor circuit to monitor power delivery to the domain, and a power control unit to control the at least one monitor circuit based on a performance state and an activity state of the domain; and
a communication interface to communicate power delivery information to a destination.

18. The system of claim 17, wherein the at least one monitor circuit comprises a configuration storage to store a first indicator to indicate whether the at least one monitor circuit is to monitor an operating voltage according to a first mode or a second mode, and a plurality of threshold storages each to store a threshold voltage associated with a frequency of the domain, the first mode comprising a minimum voltage mode, the second mode comprising an average voltage mode.

19. The system of claim 17, wherein a first domain of the plurality of domains comprises a first microbreakpoint engine to synchronize a temporal and spatial location of a voltage event with a synchronization counter.

20. The system of claim 19, wherein the power control unit is to send a stop signal to the first microbreakpoint engine responsive to a performance state change for the first domain, and the first microbreakpoint engine is to cause the at least one monitor circuit to suspend the power delivery monitoring responsive to the stop signal.

21. The system of claim 17, wherein the processor further comprises a first storage coupled to the power control unit, the first storage including a plurality of fields each associated with one of the plurality of domains to store an enable indicator to indicate whether the power delivery monitoring is to be enabled, the first storage visible to one or more of an operating system (OS) and a basic input output system (BIOS).

22. The system of claim 17, wherein the at least one monitor circuit is to monitor an operating voltage provided to the domain.
